(19) United States
(12) Patent Application Publication
(10) Pub. No.: US 2021/0279786 A1
(43) Pub. Date: Sep. 9, 2021

(54) Methods and Systems for Managing Digital Looks

(71) Applicant: Stella & Dot LLC, Groveport, OH (US)

(72) Inventors: So-Yeon OAK, San Francisco, CA (US); Peter Taylor SIMPSON, Seattle, WA (US); Hubenya Svyatoslav SVYATOSLAVOVICH, Brier, WA (US); Alice CHEN, San Carlos, CA (US); Alejandra MEZA, San Bruno, CA (US); Ryan ARP, Chattanooga, TN (US)

(21) Appl. No.: 17/193,161

(22) Filed: Mar. 5, 2021

Related U.S. Application Data
(60) Provisional application No. 62/986,214, filed on Mar. 6, 2020.

(51) Int. Cl. G06Q 30/06; G06Q 30/02; G06F 16/955; G06T 13/40

(52) U.S. Cl. CPC G06Q 30/0627; G06Q 30/0643; G06T 13/40; G06F 16/9554; G06Q 30/0283

(57) ABSTRACT

The present disclosure provides methods and systems for managing digital looks. The method may comprise providing access to a digital look. The digital look may comprise a virtual arrangement of one or more fashion articles selected by an algorithm or an individual who is not a consumer. The method may further comprise providing a user interface for a consumer to (i) view and modify the one or more fashion articles in the digital look and (ii) select at least one or more fashion articles to purchase. The user interface may comprise a purchase list corresponding to the one or more fashion articles in the digital look. Modifying the one or more fashion articles in the digital look may comprise rearranging, add, removing, or customizing one or more fashion articles.

### CROSS REFERENCE

This application claims priority to U.S. Provisional Application No. 62/986,214 filed on Mar. 6, 2020, which application is incorporated herein by reference in its entirety for all purposes.

### BACKGROUND

Digital and online interfaces may be used to help stylists design or create a desired look for consumers. Digital and online interfaces may also help consumers to visualize and decide on an outfit, which may include various articles of clothing and/or a selection of fashion accessories. Consumers and stylists may customize looks to match the consumer's personal style, preferences, or mood, or to design a fashionable appearance that is appropriate for a certain environment, venue, occasion, event, or setting.

### SUMMARY

Recognized herein are various limitations with digital and online interfaces currently available for creating virtual looks. Digital and online interfaces may permit a consumer or stylist to select various articles of clothing and/or fashion accessories for a desired look. However, digital and online interfaces currently available may limit how consumers can interact with and/or customize looks already created by stylists. Provided herein are methods and systems for managing looks that can enhance a stylist's ability to create and share a look, and a consumer's ability to view and modify a shared look to match his or her personal style. The methods and systems disclosed herein can enhance a stylist's ability to create and/or share customized looks with consumers, by allowing the stylist to share one or more looks via a link to the stylist's online fashion show or online trunk show. The methods and systems disclosed herein may allow a stylist to attach a link to her online trunk show to the one or more looks, before sharing her online trunk show link to her customers. Customers who receive the stylist's online trunk show link may then view one or more shared looks within an online trunk show that is accessible using the stylist's online trunk show link. The methods and systems disclosed herein may also allow a consumer to review a shared selection of fashion products and to customize, modify, add, remove, or interchange different components of an outfit or a look before purchasing the outfit or one or more components of the outfit. The methods and systems disclosed herein may allow a consumer to view a purchase list that is updated in real-time based on the consumer's selection, addition, removal, and/or modification of one or more components of the outfit or the look.

In an aspect, the present disclosure provides methods for managing digital or virtual looks. The methods disclosed herein may comprise providing access to a digital or virtual look. The digital or virtual look may comprise a virtual arrangement of one or more fashion articles. The one or more fashion articles may be selected by an individual who is not a consumer. For example, the fashion articles, whether individual or bundled, may be manually selected by one or more stylists who are creating the look. The one or more stylists may customize bundled items or products to decide which variations of the items or products in the bundle to add to the look. In some cases, the fashion articles may be selected by an algorithm that is configured to select one or more fashion articles automatically based on a consumer's preferences or user profile.

In some embodiments, the method may further comprise providing a user interface for a stylist and/or a consumer to (i) view and modify the look and (ii) select one or more fashion articles to purchase. Modifying the look may comprise rearranging, add, removing, or customizing one or more fashion articles. The user interface may provide the stylist and/or the consumer with different abilities to view and modify one or more items within the look. In some cases, the consumer may modify the look by (i) removing one or more items the consumer does not want to purchase and/or (ii) customizing one or more characteristics of the fashion articles within the shared look, such as a size, a color, and/or a style variation. In some embodiments, the user interface may comprise a purchase list corresponding to the one or more fashion articles selected for purchasing. In some embodiments, the user interface may be configured to display a shared look adjacent to a list of items in the shared look. The shared look may comprise an image of the one or more items within the shared look on a left portion of the user interface. The image of the shared look may be displayed adjacent to a list of items in the shared look, which list of items may be displayed on a right portion of the user interface. In any of the embodiments described herein, a consumer may modify the purchase list by unselecting or removing an item from the list of products in the shared look, or by customizing the items.

In another aspect, the present disclosure provides a method for managing a digital look, the method comprising: (a) providing a consumer with access to the digital look, wherein the digital look comprises a virtual arrangement of one or more tangible fashion articles selected by an algorithm or an individual who is not the consumer; and (b) providing a user interface for the consumer to (i) view and modify the one or more tangible fashion articles in the digital look and (ii) select at least one or more tangible fashion articles to purchase, wherein the user interface is configured to provide the consumer with a purchase list corresponding to the one or more tangible fashion articles shown in the digital look.

In some embodiments, modifying the one or more fashion articles in the digital look comprises rearranging, add, removing, or customizing the one or more fashion articles associated with the digital look.

In some embodiments, customizing the one or more fashion articles comprises (i) modifying or altering a portion, a component, or a characteristic of the one or more fashion articles or (ii) interchanging the one or more fashion articles with another fashion article or a variant of the one or more fashion articles.

In some embodiments, the characteristic of the one or more fashion articles comprises a size, a color, a shape, or a style of the one or more fashion articles.

In some embodiments, the method further comprises, prior to (a), generating the digital look using a digital canvas.

In some embodiments, generating the digital look comprises searching for one or more candidate fashion articles, selecting at least a subset of the one or more candidate fashion articles, and virtually arranging the at least the subset of the one or more candidate fashion articles on the digital canvas.

In some embodiments, the one or more candidate fashion articles are selected based on a consumer preference, a consumer purchase history, a consumer profile, a consumer request, a consumer instruction, or one or more consumer responses to a questionnaire or survey.

In some embodiments, virtually arranging the at least the subset of the one or more candidate fashion articles comprises resizing a virtual representation of a candidate fashion article.

In some embodiments, virtually arranging the at least the subset of the one or more candidate fashion articles comprises adjusting a position or an orientation of a virtual representation of a candidate fashion article.

In some embodiments, virtually arranging the at least the subset of the one or more candidate fashion articles comprises moving a virtual representation of a first candidate fashion article in front of or behind a virtual representation of a second candidate fashion article.

In some embodiments, virtually arranging the at least the subset of the one or more candidate fashion articles comprises combining two or more candidate fashion articles or overlaying a first candidate fashion article over a second candidate fashion article.

In some embodiments, the method further comprises saving the digital look to a virtual library for sharing or customization at a later point in time.

In some embodiments, the method further comprises (i) adding the saved digital look to a digital trunk show or design session or (ii) associating the saved digital look with the digital trunk show or design session.

In some embodiments, providing access to the digital look comprises sharing the digital look with the consumer via a trunk show link configured to direct a user to a digital trunk show or design session comprising the digital look.

In some embodiments, sharing the digital look with the consumer comprises attaching the trunk show link to a saved digital look.

In some embodiments, the trunk show link comprises a hyperlink, an embedded text link, an embedded image link, or a scannable element.

In some embodiments, the scannable element comprises a barcode or a Quick Response (QR) code.

In some embodiments, the user interface is configured to update the purchase list or an item pricing in real time based on (i) the consumer's selection of the one or more fashion articles for purchasing or (ii) the consumer's modification or customization of the digital look or one or more fashion articles associated with the digital look.

In another aspect, the present disclosure provides a system for managing digital looks, comprising: (a) a computing device configured to provide a consumer with a link to access a digital look, wherein the digital look comprises a virtual arrangement of one or more fashion articles selected by an algorithm or an individual who is not the consumer; and (b) a digital platform configured to provide a user interface for the consumer to (i) view and modify the one or more fashion articles in the digital look and (ii) select at least one or more fashion articles to purchase, wherein the user interface is configured to provide the consumer with a purchase list corresponding to the one or more fashion articles in the digital look.

In some embodiments, the user interface is configured to update the purchase list or an item pricing in real time based on (i) the consumer's selection of the one or more fashion articles for purchasing or (ii) the consumer's modification or customization of the digital look or one or more fashion articles associated with the digital look.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIGS. 1A, 1B, 1C, and 1D schematically illustrate a user interface configured to provide a user with access to a design tool for creating one or more looks, in accordance with some embodiments.

FIGS. 2A and 2B schematically illustrate a product search interface that is usable to select one or more items in order to create a look, in accordance with some embodiments.

FIGS. 3A and 3B schematically illustrate an item of interest selected either from the product search interface or a product categories browsing interface, in accordance with some embodiments.

FIG. 4 schematically illustrates a virtual canvas configured to allow resizing and/or rotating of an item of interest by manipulating a bounding box drawn around the item of interest, in accordance with some embodiments.

FIG. 5 and FIG. 6 schematically illustrate customizable items of interest, in accordance with some embodiments.

FIG. 7 schematically illustrates a plurality of items of interest arranged on a virtual canvas, in accordance with some embodiments.

FIG. 8 schematically illustrates a tool bar, in accordance with some embodiments.

FIG. 9 schematically illustrates a customizable item of interest combined with an item of interest, in accordance with some embodiments.

FIG. 10 schematically illustrates a plurality of item combinations, in accordance with some embodiments.

FIG. 11 schematically illustrates a save button configured to save a look, in accordance with some embodiments.

FIG. 12 schematically illustrates a saved look, in accordance with some embodiments.

FIGS. 13A and 13B schematically illustrate a user interface for customizing a saved look, in accordance with some embodiments.

FIGS. 14A, 14B, and 14C schematically illustrate an interface for adding a saved look to a stylist's online or digital trunk show or design session, in accordance with some embodiments.

FIGS. 15A and 15B schematically illustrate a saved look that is shared with a consumer, in accordance with some embodiments.

FIGS. 16A and 16B schematically illustrate a look that is accessible by a consumer through a stylist's digital trunk show after the stylist attaches a link to the stylist's digital trunk show to the look, in accordance with some embodiments.

FIG. 17 schematically illustrates a list of items corresponding to one or more items in a saved look, in accordance with some embodiments.

FIGS. 18A and 18B schematically illustrate a purchase list corresponding to one or more items in a saved look, in accordance with some embodiments.

FIG. 19 schematically illustrates a plurality of methods for sharing a saved look, in accordance with some embodiments.

FIG. 20 schematically illustrates a user interface for managing saved looks, in accordance with some embodiments.

FIG. 21 schematically illustrates a plurality of saved looks accessible through the user interface, in accordance with some embodiments.

FIG. 22 schematically illustrates an interface for sharing, editing, and deleting saved looks, in accordance with some embodiments.

FIG. 23 schematically illustrates a computer system that is programmed or otherwise configured to implement methods provided herein.

### DETAILED DESCRIPTION

The present disclosure provides methods and systems for managing digital or virtual looks. As used herein, the term “digital look” may be referred to interchangeably as a “virtual look” or a “look.” As described herein, a digital or virtual look may refer to a digital or virtual representation of one or more wearable items, such as articles of clothing and/or one or more fashion accessories. The one or more articles of clothing and the one or more fashion accessories may correspond to one or more physical or virtual items or products that may be purchasable by a consumer. The one or more articles of clothing may comprise clothing such as pants, jeans, leggings, shorts, dresses, skirts, tops, shirts, blouses, undergarments, sweaters, jackets, coats, and/or other garments that are wearable by a consumer. The one or more fashion accessories may include handbags, purses, belts, shoes, scarves, ties, jewelry, timepieces, sunglasses, hats, and/or other complementary articles for wear by a consumer.

A digital or virtual canvas may be used to create one or more digital or virtual looks. The digital or virtual canvas may be configured to display one or more items within a look. The one or more looks may comprise a digital or virtual arrangement of one or more products or items. The one or more looks may comprise a listing or a collection of products or items that are digitally or virtually represented. As used herein, the term “product(s)” or “item(s)” may refer to one or more wearable items, such as one or more articles of clothing and/or one or more fashion accessories that may be viewed and/or purchased by a consumer. The term “product(s)” or “item(s)” may further refer to a collection and/or a combination of one or more articles of clothing and/or one or more fashion accessories that may be viewed and/or purchased by a consumer.

Digital Canvas

In an aspect, the present disclosure provides a digital canvas for creating, sharing, and/or modifying one or more looks. As used herein, the term “digital canvas” may be referred to interchangeably as a “virtual canvas.” The digital canvas or virtual canvas may be configured to provide a user (e.g., a consumer and/or a stylist) with a virtual or digital environment for the user to create one or more virtual looks. The one or more virtual looks may comprise a digital or virtual representation of one or more physical or tangible articles of clothing and/or one or more physical or tangible fashion accessories. The one or more physical or tangible articles of clothing or fashion accessories may be purchasable by the consumer. The digital or virtual representation of the one or more physical or tangible articles of clothing and/or the one or more fashion accessories may comprise a computer-generated visualization of the one or more articles of clothing and/or the one or more fashion accessories. The computer-generated visualization may comprise a virtual space or a virtual canvas in which the one or more articles of clothing and/or the one or more fashion accessories may be placed, manipulated (e.g., resized, rotated, customized, engraved, or brought in front of or behind other items), arranged, rearranged, and/or viewed. The one or more articles of clothing and/or the one or more fashion accessories virtually represented in the virtual space or the virtual canvas may correspond to one or more physical or virtual items or products that may be purchasable by a consumer.

In some cases, the virtual space may comprise a two-dimensional virtual space. The two-dimensional virtual space may be configured to allow a user (e.g., a consumer and/or a stylist or ambassador) to view, modify, add, remove, arrange, and/or rearrange one or more virtually represented products or items in a virtual two-dimensional plane. In some embodiments, the virtual space may be configured to allow a stylist (also referred to interchangeably as an ambassador) to add, modify, remove, view, and/or rearrange one or more items within the virtual space. In some embodiments, the virtual space may be configured to allow a consumer to view the shared look and to choose one or more items within the shared look to purchase. The one or more items may be selected for purchasing using a purchase list comprising the one or more items within the shared look. In some embodiments, the virtual space may be configured to allow a consumer to modify or customize one or more characteristics (e.g., a size, a color, a shape, and/or a style) of an item within the virtual space before selecting the item for purchasing. In other cases, the virtual space may comprise a three-dimensional virtual space. The three-dimensional virtual space may be configured to allow a user (e.g., a consumer and/or a stylist) to view, modify, add, remove, arrange, and/or rearrange one or more virtually represented products or items in a virtual three-dimensional space. In some cases, the three-dimensional virtual space may be configured to allow a user to view and/or manipulate a three-dimensional virtual representation of one or more products or items. In any of the embodiments described herein, the virtual space or virtual canvas may be configured to provide one or more two-dimensional digital or virtual representations of one or more products or items. In any of the embodiments described herein, the virtual space or virtual canvas may be configured to provide one or more three-dimensional digital or virtual representations of one or more products or items. The one or more three-dimensional digital or virtual representations may be manipulated by a user to visualize one or more products or items from a plurality of different perspectives or viewpoints.

Looks

The virtual or digital canvas may be configured to allow a user, such as a consumer and/or a stylist, to select and add articles of clothing and/or fashion accessories to the virtual or digital canvas to create, edit, modify, and/or manage a look. As described herein, a look may refer to a customizable digital collection or a customizable virtual representation of one or more products or items (i.e., one or more articles of clothing and/or one or more fashion accessories). A look may be generated or created by arranging one or more products or items on a virtual canvas such that the one or more products or items are laid out for a user to view and inspect the one or more products or items individually or collectively. In some cases, a look may be generated or created by arranging one or more products or items on a virtual model of a human. The virtual model of the human may correspond to a size and/or a shape of a consumer's body. In other cases, a look may be generated or created by arranging one or more products or items on a graphical representation of a human or a human body. The graphical representation may comprise an image of a human, an image of a human body, and/or an image of one or more parts of a human body. In some cases, a look may be generated by selecting one or more items. When the one or more items are selected, one or more images of the selected items may be added to the digital canvas. The one or more images of the selected items may comprise a transparent background for ease of visualization and arrangement. In some cases, the one or more images of the selected items may comprise one or more models wearing the items to provide a realistic representation of how the selected items look when worn. A look may be generated or created based on a selection of one or more articles of clothing and/or one or more fashion accessories. The one or more articles of clothing and/or one or more fashion accessories may be selected by a consumer, a stylist, and/or an algorithm.

In some cases, the one or more articles of clothing and/or one or more fashion accessories may be selected by a consumer or a stylist/ambassador. A consumer may comprise an individual who is interested in viewing, browsing, and/or purchasing one or more articles of clothing and/or one or more fashion accessories. In some cases, a consumer may comprise an individual who wants to understand what items of clothing and accessories will go well together and look good on her so that she may decide what to purchase. A stylist may comprise an individual who creates one or more looks to share with a consumer. In some cases, a stylist may be an individual who curates one or more articles of clothing and/or one or more fashion accessories to create a look. In some cases, a stylist may be an individual who recommends one or more looks to a consumer based on the consumer's preferences, past purchases, user profile, or requests. In any of the embodiments described herein, the stylist may not or need not be a consumer.

In some cases, the one or more articles of clothing and/or one or more fashion accessories may be selected by an algorithm. The algorithm may be configured to select one or more products or items based at least in part on a user's instructions, preferences, profile, and/or past purchases. The algorithm may be configured to determine an appropriate selection of products or items based at least in part on one or more answers, comments, or responses provided by a user (e.g., a consumer or a stylist) in relation to a questionnaire, survey, or online form completed by the user.

Methods of Implementation

The systems and methods disclosed herein may be implemented using an electronic device. The electronic device may comprise a mobile device (e.g., a smartphone), a handheld device, a desktop computer, a laptop computer, a netbook, an electronic tablet or similar device, a networking device, a personal digital assistant, a wearable device, a head mounted computer or display, or any other device, component, module, subsystem or system capable of generating a visual representation of one or more articles of clothing and/or one or more fashion accessories.

In some embodiments, the methods and systems disclosed herein may be implemented using a mobile application. The mobile application may be provided and/or accessible on an electronic device (e.g., a mobile device, a laptop computer, and/or a desktop computer). The mobile application may be used to generate, manage, modify, and/or share one or more looks. In some cases, the mobile application may provide one or more user interfaces for a user (e.g., a consumer or a stylist) to create, modify, save, share, and/or manage (i) one or more looks and/or (ii) one or more items within a look.

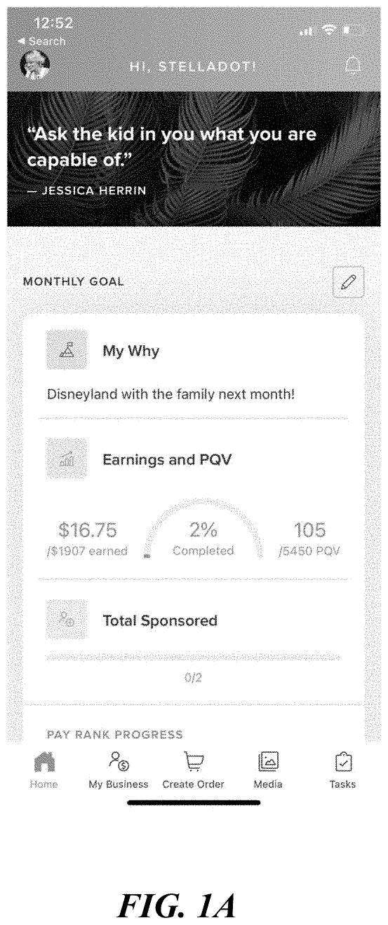

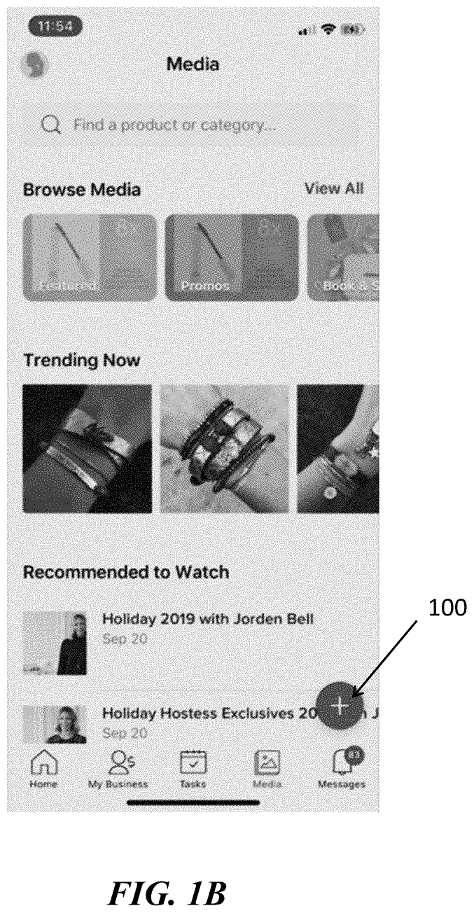

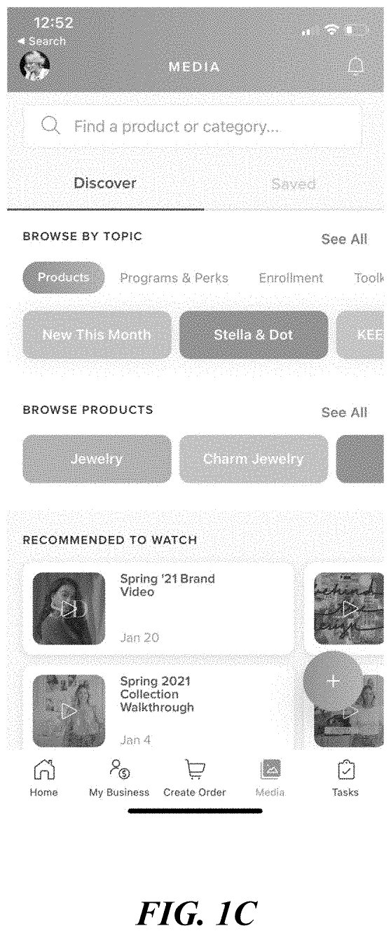

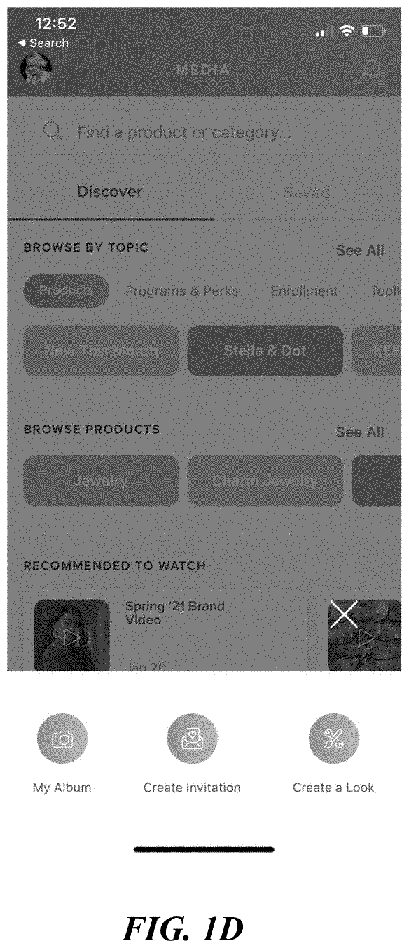

FIG. 1A illustrates an exemplary home page of the user interface. The user interface may provide the user with the option of viewing details pertaining to the user's business, creating orders, viewing media, and/or tracking various tasks.

Item Searching

The user interface may be configured to allow a user to search for and select one or more products or items. As shown in FIGS. 1B and 1C, the user interface may comprise a media tab. The media tab may comprise an interactive button that a user may press to access a design tool for creating one or more looks. The one or more looks may comprise one or more items, products, and/or accessories that the user can browse or search for using the user interface. The user interface may be configured to organize the items, products, and/or accessories by category. The one or more items, products, and/or accessories may be curated manually by browsing and searching for items and selecting items to add to a look. In some cases, the one or more items, products, and/or accessories may be curated or presented to the user based at least in part on a user's preferences, browsing history, past purchases, or user profile. As shown in FIG. 1D, the user interface may be configured to provide the user with options for viewing an album comprising various media, creating an invitation, and creating a look.

In some cases, the media tab may comprise a plurality of interactive elements (e.g., buttons) that a user may interact with (e.g., press or tap) to create a look. The plurality of interactive elements may be configured to respond to one or more touch gestures (e.g., tap, double tap, flick, drag, spread, pan, zoom, swipe, pinch, and/or rotate) received from a user. The plurality of interactive elements may comprise a “Create a Look” button 100 that enables a user, a stylist, and/or a consumer to create a look using a digital or virtual canvas.

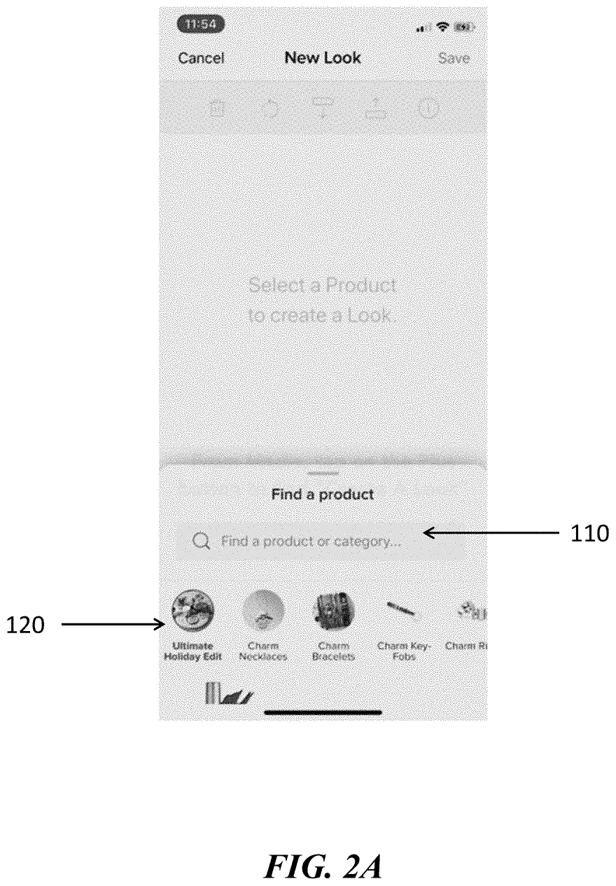

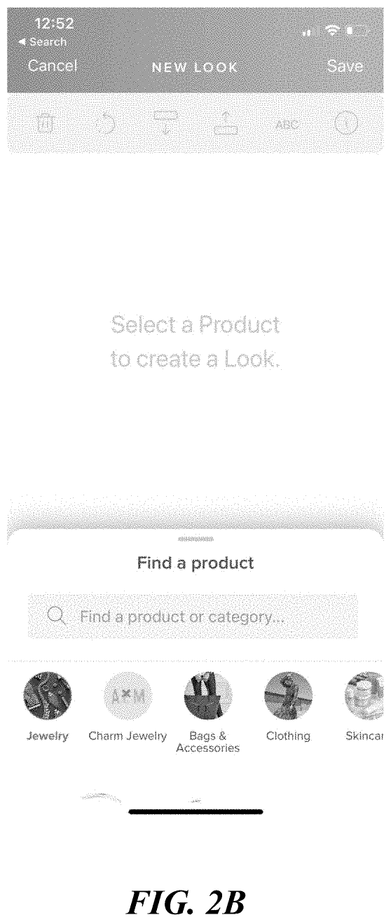

When a user interacts with the “Create a Look” button 100 (e.g., by tapping, touching, or pressing), the user interface may be configured to direct the user to a product search interface. The product search interface may comprise a product search bar 110 and a product category panel 120, as illustrated in FIGS. 2A and 2B. The product search bar 110 may be configured to allow a user to search for a product or an item (i.e., an article of clothing and/or a fashion accessory) by typing or providing a search term. The search term may comprise at least a portion of a name of a product or a description of a product (e.g., type of product, color of product, etc.). The product category panel 120 may comprise an arrangement of a plurality of interactive elements indicating one or more distinct product categories. The arrangement of the plurality of interactive elements may be linear, horizontal, vertical, or circular. When pressed, each of the plurality of interactive elements may be configured to display a list or an arrangement of one or more products or items that fall within the one or more product categories associated with each interactive element.

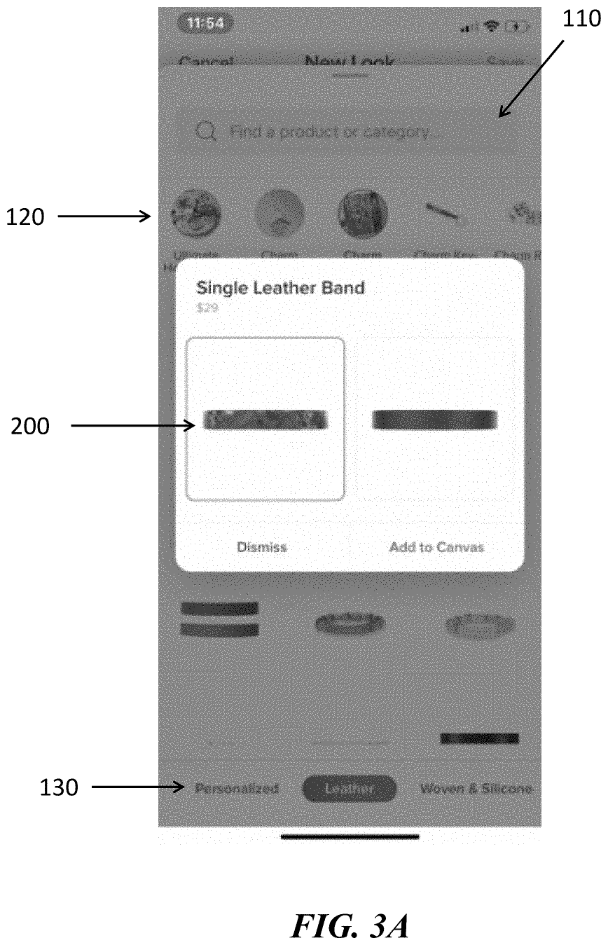

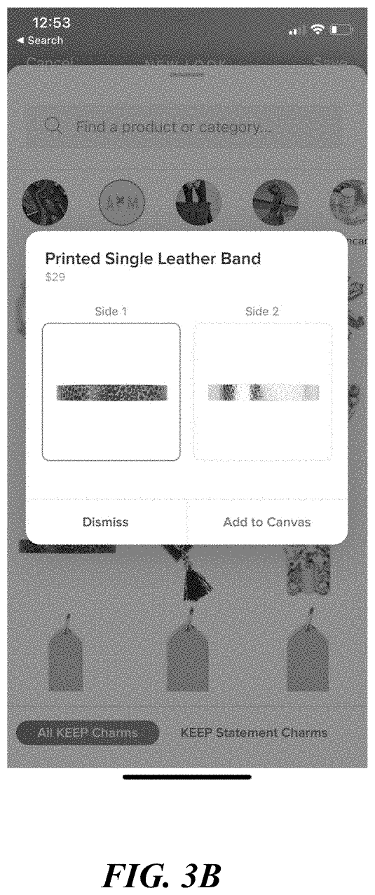

As shown in FIGS. 3A and 3B, the user interface may be configured to provide a search bar 110 for a user to search for and/or locate one or more articles of clothing and/or one or more fashion accessories using a search string associated with a specific item or a description of the item. In some cases, the user interface may be configured to provide a product category panel 120 to allow a user to browse through a plurality of purchasable items by category. In some cases, the user interface may be configured to allow a user to view and/or sort purchasable items or products by product subcategories 130. The product subcategories 130 may be associated with different types of clothing or fashion accessories. The product subcategories 130 may group items or products by type, price, color, material, size, shape, construction, and/or theme.

Item Selection

When a user finds an item of interest 200 using the product search bar 110, the product category panel 120, and/or the product subcategories 130, the user may select the item of interest 200 to add a virtual canvas. The item of interest 200 may correspond to a product or an item that the user has viewed and/or located while browsing through a collection of purchasable items comprising one or more articles of clothing and/or the one or more fashion accessories. In some cases, the item of interest may correspond to a product or an item that the user viewed and/or located while sorting through purchasable items using one or more product categories or product subcategories.

When a user selects an item of interest 200, the user interface may be configured to provide the user with an enlarged visualization of the item of interest 200. In some cases, the item of interest 200 may comprise a reversible item having two or more sides with different visual appearances. In such cases, the user interface may be further configured to provide the user with an enlarged visualization of both sides of the item of interest 200. Each side of the reversible item of interest 200 may have a different design, material, pattern, or color. When a user confirms a selection of the item of interest 200 or a selection of the one or more additional products or items, the user interface may be configured to add the item of interest 200 or the one or more additional products or items to the virtual space or virtual canvas. The item of interest 200 or the one or more additional products or items may then appear within the virtual space or the virtual canvas. In some cases, the one or more additional products or items may be selected as the item of interest 200. Upon selection, the item of interest 200 or the one or more additional products or items may be digitally or virtually represented within the virtual space or the virtual canvas.

In any of the embodiments described herein, the item of interest 200 may comprise a plurality of products or items of interest. In some cases, the user may select a plurality of items of interest to add to the virtual canvas.

Item Arrangement

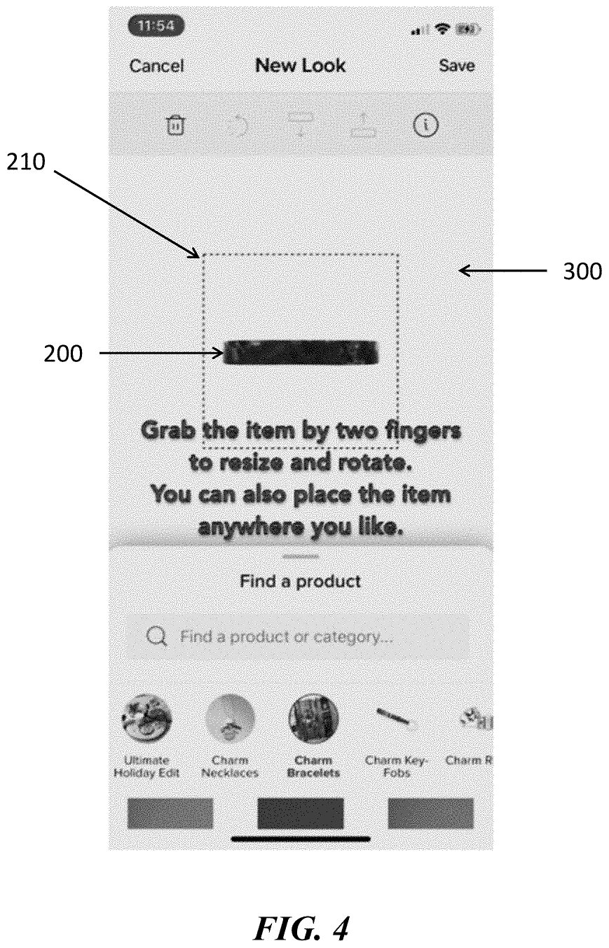

FIG. 4 illustrates a virtual canvas 300 on which user-selected items of interest 200 may be placed and/or arranged. The virtual canvas 300 may be configured to generate a bounding box 210 around an item of interest 200 when the item of interest 200 is added to the virtual canvas 300. In some cases, the virtual canvas 300 may be configured to generate a bounding box 210 around an item of interest 200 when the user presses and/or taps the virtual representation of the item of interest 200. The bounding box 210 may surround the item of interest 200. The bounding box 210 may be an interactive element that permits a user to modify and/or reposition the item based on a user input. Modifying the item may comprise rotating, shrinking, expanding, and/or moving the virtual representation of the item. The user input may comprise a pinch gesture, a zoom gesture, a rotation gesture, a pan gesture, and/or a swipe gesture. The bounding box 210 may comprise a bounding box shape. The bounding box shape may be a circle, a triangle, a square, a diamond, or a rectangle. In some cases, the bounding box shape may comprise a polygon with at least three or more sides. The at least three or more sides may comprise a same length. Alternatively, the at least three or more sides may comprise different lengths.

In some cases, the virtual canvas may be configured to allow a user, a consumer, and/or a stylist to rearrange, resize, and/or reposition the articles of clothing and/or the fashion accessories within the look. In some cases, the virtual canvas may be further configured to allow a user, a consumer, or a stylist to add and/or remove one or more items from the virtual canvas.

In some cases, the user interface may be configured to provide a product search bar and/or a product category panel underneath the virtual canvas. In such cases, a user may use the product search bar and/or the product category panel to search for, view, and add additional items of interest to the virtual canvas.

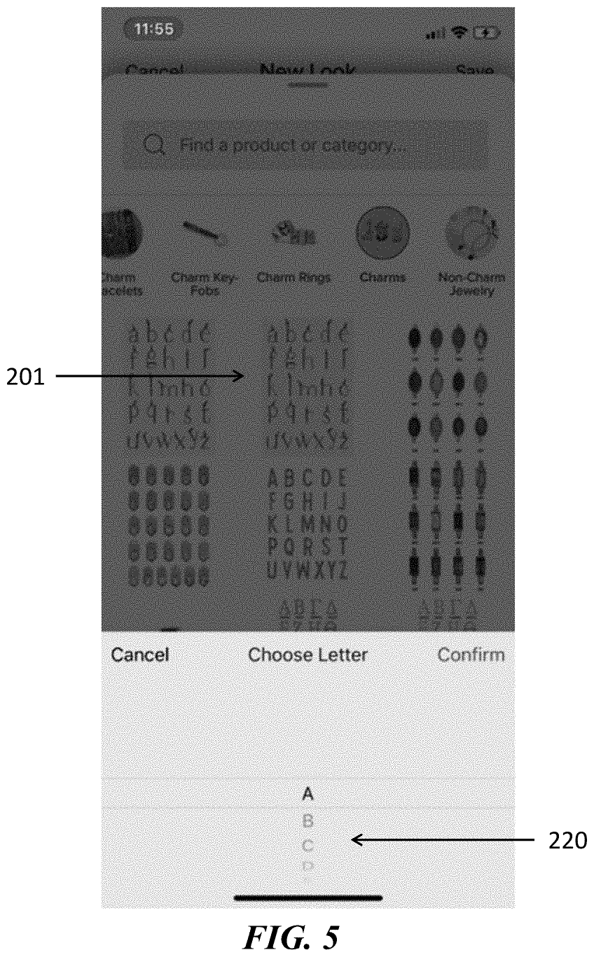

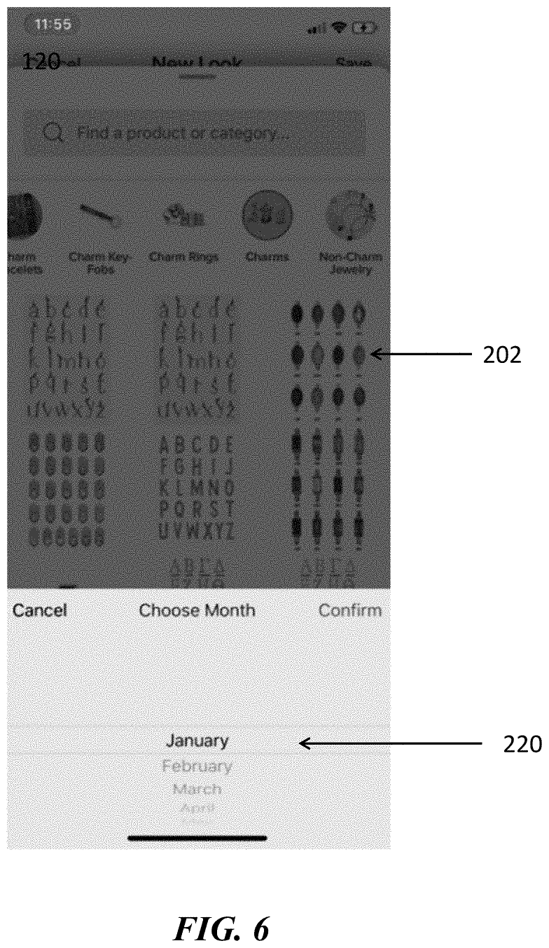

In any of the embodiments described herein, the user interface may be configured to allow a user to select one or more customizable items of interest. As shown in FIG. 5 and FIG. 6, the one or more customizable items of interest 201 and 202 may be configured to allow a user to select a customizable feature. The customizable feature may correspond to a letter, a number, a color, a day, a month, and/or a year. The user interface may be configured to provide a feature selection wheel 220 that enables a user to select a customizable feature for a customizable item of interest 201 or 202. The feature selection wheel 220 may be configured to allow a user to browse and/or navigate through a plurality of customizable features using one or more touch gestures (e.g., tap, double tap, flick, drag, spread, pan, zoom, swipe, pinch, and/or rotate).

Arrangement of Multiple Items

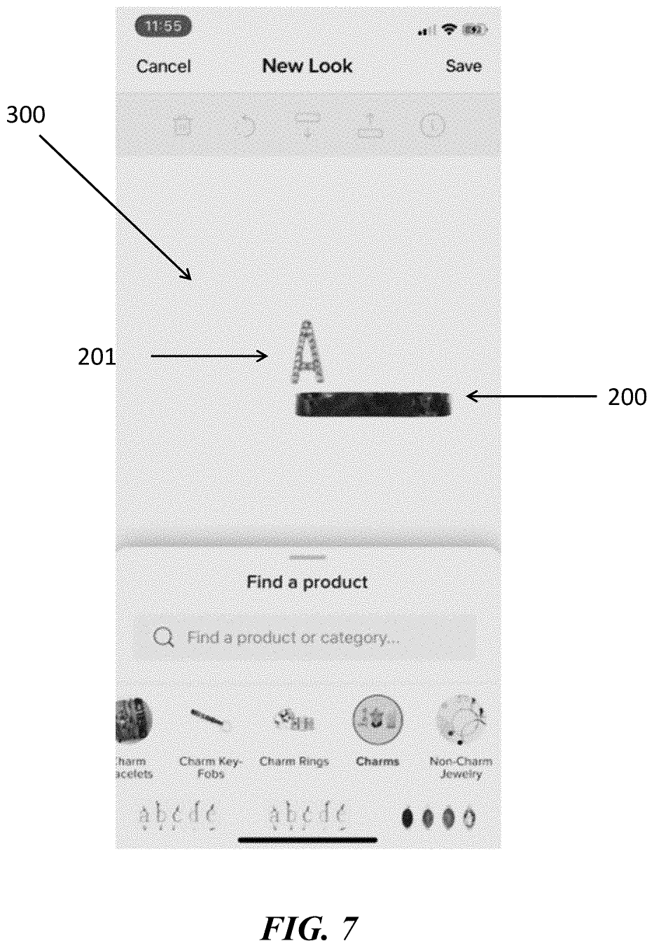

In any of the embodiments described herein, the virtual canvas may be configured to display a plurality of items of interest. As shown in FIG. 7, the plurality of items of interest may comprise one or more items of interest 200 and/or one or more customizable items of interest 201. The plurality of items of interest may be arranged in various configurations (i.e., positions and/or orientations) on the virtual canvas relative to each other. The plurality of items of interest may be arranged using one or more touch gestures provided by a user.

In some cases, the virtual canvas may be configured to arrange the plurality of items of interest in various configurations relative to one another to correspond to how the plurality of items would be arranged when worn. For example, when a user selects a first article of clothing (e.g., a jacket or a coat) and a second article of clothing (e.g., a pair of pants), the virtual canvas may be configured to arrange the first article of clothing (e.g., the jacket or the coat) above the second article of clothing (e.g., the pair of pants) to show a consumer how the first article of clothing and the second article of clothing may look when worn together by the consumer. In another example, when a user selects a first fashion accessory (e.g., a necklace) and a second fashion accessory (e.g., a charm), the virtual canvas may be configured to arrange the second fashion accessory (e.g., the charm) in a suspended configuration underneath a portion of the first fashion accessory (e.g., the necklace) to show a consumer how the first fashion accessory and the second fashion accessory may look when worn together by the consumer. In another example, when a user selects an article of clothing (e.g., a shirt) and a fashion accessory (e.g., a wrist bracelet), the virtual canvas may be configured to arrange the fashion accessory (e.g., the wrist bracelet) adjacent to a sleeve of the article of clothing (e.g., the shirt) to show a consumer how the fashion accessory and the article of clothing may look when worn together by the consumer. In another example, when a user selects an article of clothing (e.g., a shirt) and a fashion accessory (e.g., a necklace), the virtual canvas may be configured to arrange the fashion accessory (e.g., the necklace) in a suspended configuration from a neckline of the article of clothing (e.g., the shirt) to show a consumer how the fashion accessory and the article of clothing may look when worn together by the consumer.

In other cases, the virtual canvas may be configured to allow a user to arrange the plurality of items of interest in various configurations relative to one another to correspond to how the plurality of items would be arranged when worn. For example, when a user selects a first article of clothing (e.g., a blouse or a sweater) and a second article of clothing (e.g., a pair of leggings), the virtual canvas may be configured to allow the user to arrange the first article of clothing (e.g., the blouse or the sweater) above the second article of clothing (e.g., the pair of leggings) to show a consumer how the first article of clothing and the second article of clothing may look when worn together by the consumer. In another example, when a user selects a first fashion accessory (e.g., a necklace) and a second fashion accessory (e.g., a charm), the virtual canvas may be configured to allow the user to arrange the second fashion accessory (e.g., the charm) in a suspended configuration underneath a portion of the first fashion accessory (e.g., the necklace) to show a consumer how the first fashion accessory and the second fashion accessory may look when worn together by the consumer. In another example, when a user selects an article of clothing (e.g., a shirt) and a fashion accessory (e.g., a wrist bracelet), the virtual canvas may be configured to allow the user to arrange the fashion accessory (e.g., the wrist bracelet) adjacent to a sleeve of the article of clothing (e.g., the shirt) to show a consumer how the fashion accessory and the article of clothing may look when worn together by the consumer. In another example, when a user selects an article of clothing (e.g., a shirt) and a fashion accessory (e.g., a necklace), the virtual canvas may be configured to allow the user to arrange the fashion accessory (e.g., the necklace) in a suspended configuration from a neckline of the article of clothing (e.g., the shirt) to show a consumer how the fashion accessory and the article of clothing may look when worn together by the consumer.

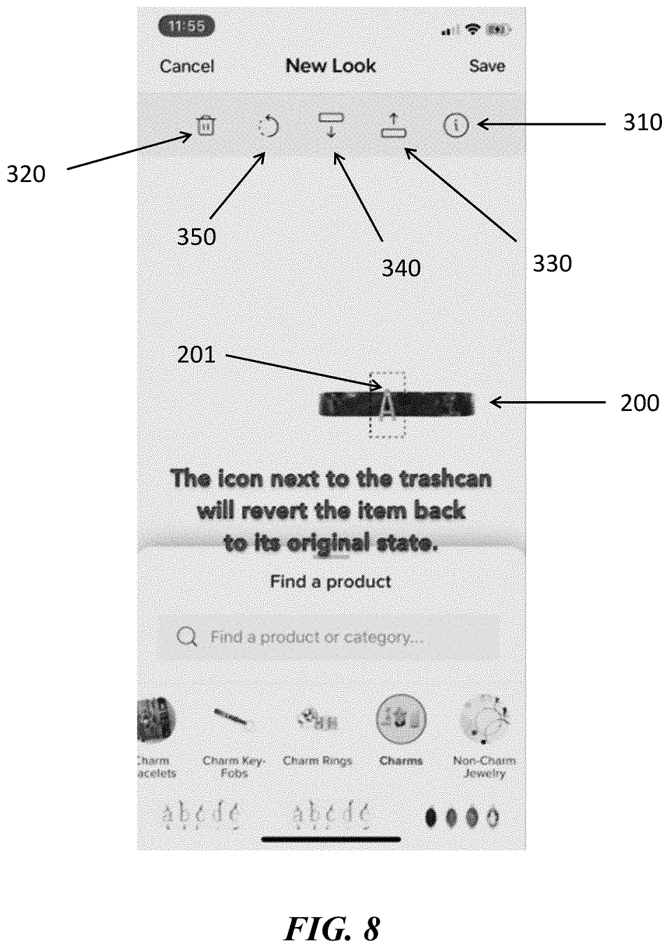

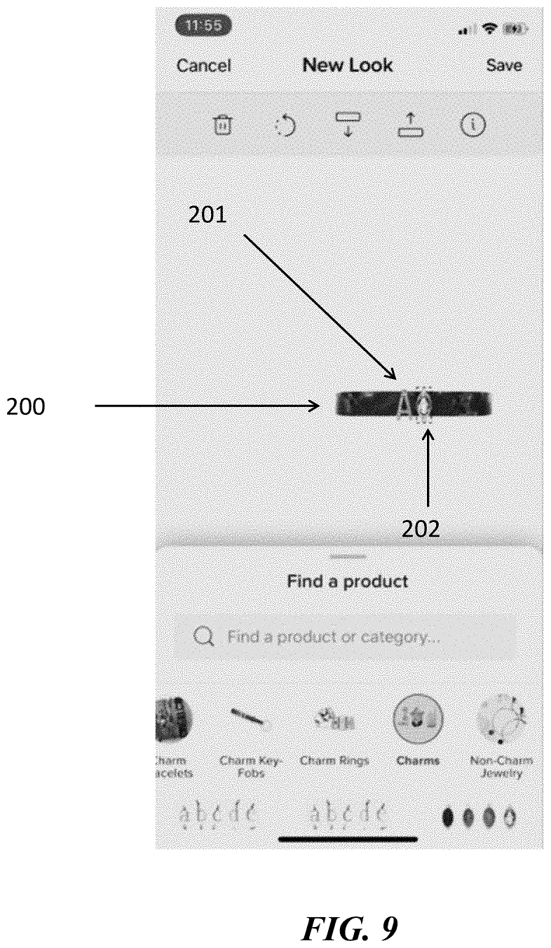

In some cases, the virtual canvas may be further configured to allow a user, a consumer, and/or a stylist to combine and/or overlay one or more items of interest to create one or more virtual combinations of items. As shown in FIG. 8 and FIG. 9, the virtual canvas may be configured to allow a user to combine an item of interest 200 with one or more customizable items of interest 201 and 202. Combining a plurality of items of interest may involve placing a first item of interest on or near a second item of interest. The virtual canvas may be configured such that a user may use a bounding box generated around a first item of interest to reposition and/or place the first item of interest on or near the second item of interest. When a first item of interest is placed on or near a second item of interest, the virtual canvas may be configured to overlay the first item of interest onto the second item of interest, or vice versa. The overlay may be configured to provide a virtual representation of a first item of interest and a second item of interest when combined or used together. The virtual representation may increase or decrease a size of the first item of interest or the second item of interest to provide a visual representation of a resulting look when a first item of interest is combined with a second item of interest.

In some cases, the user interface may be configured to provide a toolbar above the virtual canvas 300. The toolbar may comprise an item description icon 310 that is configured to provide and display a description of an item that is selected within the virtual canvas 300. A selected item of interest may correspond to an item of interest with a bounding box surrounding the item of interest. The description of the item may comprise information on a price, a material, a size, and/or an item number associated with the selected item of interest.

In some cases, the tool bar may further comprise a trashcan icon 320. When pressed, the trashcan icon 320 may be configured to remove a selected item. The selected item of interest may correspond to an item of interest with a bounding box surrounding the item of interest.

In some cases, the tool bar may further comprise a move forward icon 330. When pressed, the move forward icon 330 may be configured to move a first item of interest forward relative to a second item of interest. Moving a first item of interest forward relative to a second item of interest may comprise moving the first item of interest in front of or on top of the second item of interest.

In some cases, the tool bar may further comprise a move backward icon 340. When pressed, the move backward icon 340 may be configured to move a first item of interest back relative to a second item of interest. Moving a first item of interest back relative to a second item of interest may comprise moving the first item of interest behind or underneath the second item of interest.

In some cases, the tool bar may further comprise a revert icon 350. When pressed, the revert icon 350 may be configured to revert an item of interest back to an original state. Reverting an item of interest back to an original state may comprise returning an item of interest back to a previous size, shape, orientation, or position before the item of interest was manipulated, modified, and/or repositioned within the virtual canvas. In some cases, reverting an item of interest back to an original state may comprise undoing one or more modifications performed on a virtual representation of the item of interest after the item of interest was added to the virtual canvas. The one or more modifications may comprise a change or an adjustment in a size, shape, orientation, or position of the virtual representation of an item of interest.

As shown in FIG. 9, in some cases a first customizable item of interest 201 and a second customizable item of interest 202 may be combined and/or overlaid onto an item of interest 200. In such cases, at least one of the first customizable item of interest 201 or the second customizable item of interest 202 may be resized after being combined with the item of interest 200.

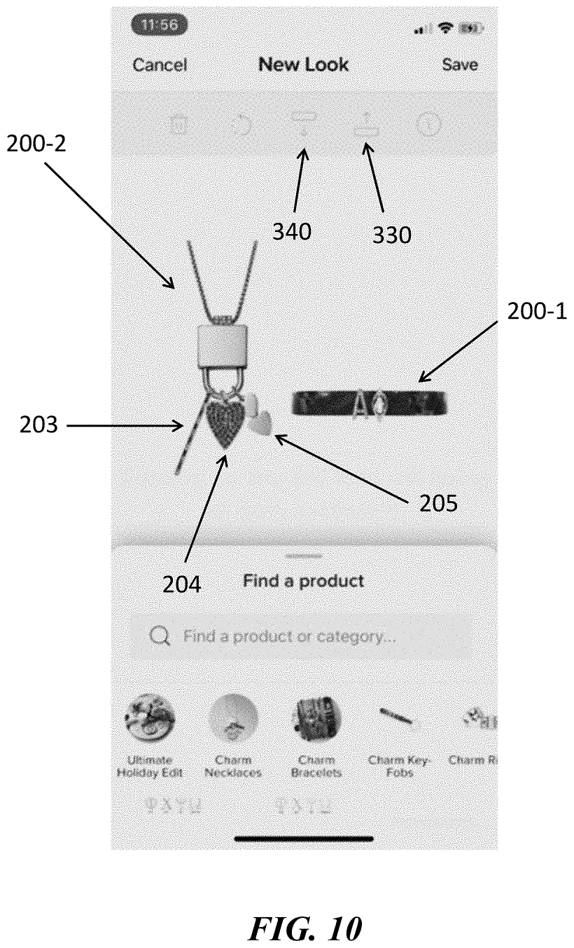

As illustrated in FIG. 10, in some cases, a user may create a plurality of item combinations 200-1 and 200-2 within the virtual canvas. In some cases, an item combination 200-1 may comprise an item of interest and a plurality of customizable items of interest. The plurality of customizable items of interest may be combined with the item of interest and/or overlaid onto a visual representation of the item of interest. In some cases, an item combination 200-2 may comprise one or more accessories 203, 204, and/or 205. The one or more accessories 203, 204, and/or 205 may be moved forward or backwards relative to each other using the move forward icon 330 or the move backwards icon 340.

Saving Looks

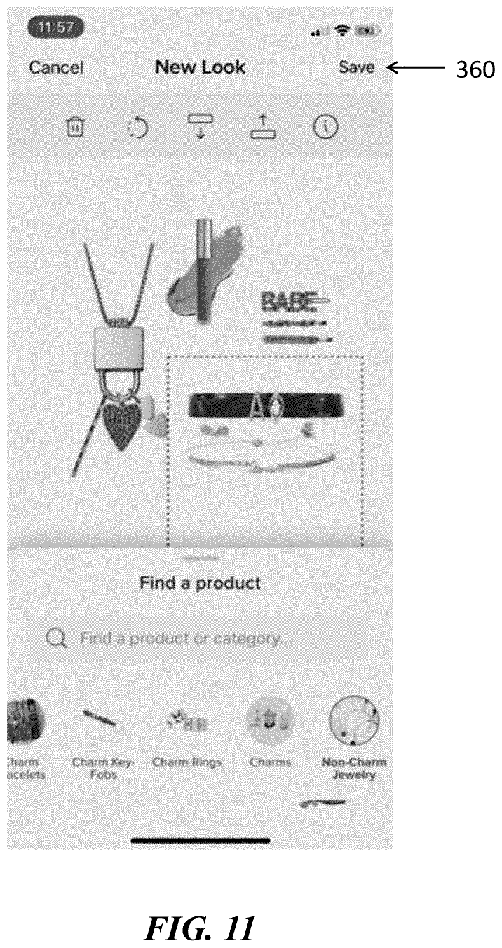

Once a user (e.g., a stylist or a consumer) selects, arranges, and/or combines a plurality of items within the virtual canvas to create a desired look, the user interface may be configured to provide the user with an option to save the created look. As shown in FIG. 11, in some cases the user interface may be configured to provide a user with a save button 360. The save button 360 may be configured to allow a user to save a look created by the user. The look may comprise the one or more items selected by the user. As described above, the one or more items may be modified, rearranged relative to each other, and/or combined within the virtual canvas before the user saves a look comprising the one or more selected items. Saving the look may generate a saved look. The saved look may comprise the one or more selected items in an arrangement or configuration customized by the user. The user may use one or more bounding boxes to arrange, rearrange, and/or combine one or more items within the virtual canvas before saving the look.

After a user, a consumer, and/or a stylist creates a desired look, the look may be saved to a collection of saved looks. In some cases, a saved look may be added to and/or associated with a stylist's online or digital trunk show or design session (also referred to interchangeably as an event). In some cases, a stylist may attach a link to the stylist's digital trunk show to the saved look. By doing so, the stylist may share the saved look with consumers using a link that allows consumers to view and/or shop the items in the shared look from within the stylist's digital trunk show. When a consumer accesses the stylist's digital trunk show via the stylist's trunk show link, the consumer may view the shared look and the one or more items within the shared look. In some cases, the consumer may access, view, modify, and/or purchase the shared look. In some cases, the consumer may modify (e.g., add, remove, or exchange) one or more items within the shared look before purchasing the look or a subset of the items associated with the saved look. In some cases, the design session may enable the user, the consumer, the stylist, and/or another consumer to access the virtual or digital canvas used to create the shared look. In some cases, the design session may enable a stylist to add a personalized message to a consumer who may be interested in viewing, modifying, and/or purchasing the saved look or the one or more items within the shared look.

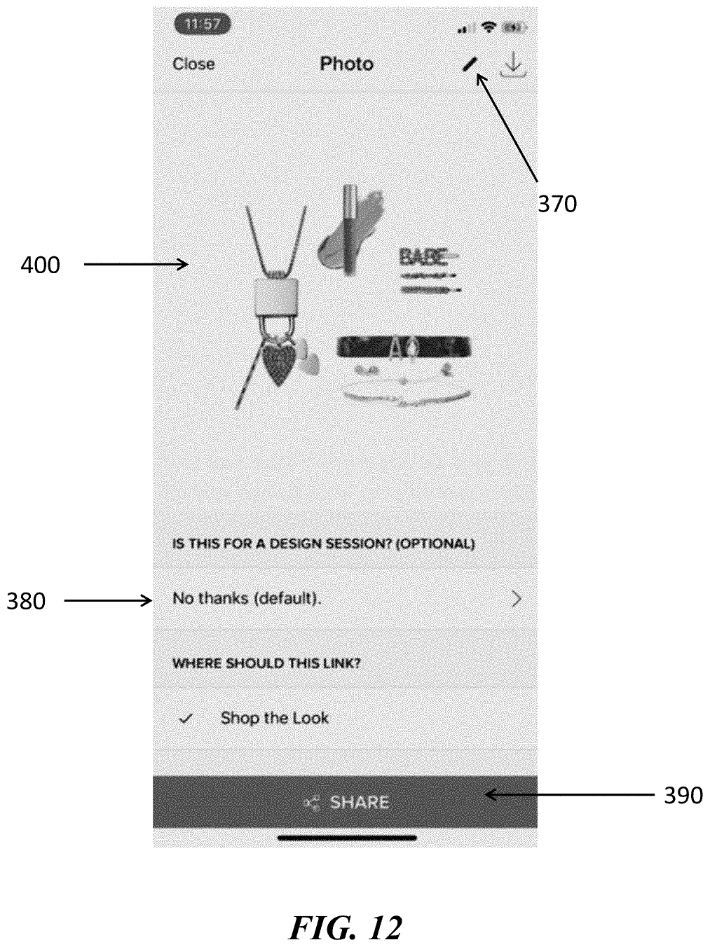

FIG. 12 illustrates a saved look 400. After a user saves a look, the user interface may be configured to provide one or more interactive elements to manage the saved look 400. For example, the one or more interactive elements may comprise an edit button 370. The edit button may comprise a pencil icon. When pressed, the edit button 370 may be configured to allow a stylist to visually customize an image of the saved look by adding one or more stickers on top of the image of the saved look, or by adding a personalized message on top of the image of the saved look, before the stylist shares the saved look with a consumer.

In some cases, the user interface may be configured to provide a design session button 380 for a stylist to attach a link to the stylist's digital trunk show to the saved look. The stylist may share the saved look with consumers using a link that allows consumers to view and/or shop the items in the look from within the stylist's digital trunk show. When a consumer accesses the stylist's digital trunk show via the stylist's trunk show link, the consumer may view the shared look and the one or more items within the shared look. In some cases, the consumer may access, view, modify, and/or purchase the shared look. In some cases, the consumer may modify (e.g., add, remove, or exchange) one or more items within the shared look before purchasing the look or a subset of the items within the shared look.

In some cases, the user interface may be configured to provide a share button 390 for a user to share the saved look 400. When a user presses or taps the share button 390, the user interface may be configured to present the user with a plurality of methods for sharing the saved look 400, as described in further detail below.

Modifying Saved Looks and Customizing Images of Saved Looks

In some cases, a saved look may be modified before the saved look is shared. Modifying the saved look may involve adding, removing, modifying (e.g., rotating, resizing, and/or repositioning), and/or exchanging one or more items within the saved look.

In some cases, an image of a saved look may be visually customized before the saved look is shared with a consumer. Customizing the image of the saved look may involve adding a message, adding customizable text, and/or adding additional design features such as stickers or frames to the image of the saved look. In some cases, customizing the image of the saved look may involve overlaying one or more images together. The one or more images may comprise an image, a photograph, or a screen capture of the saved look.

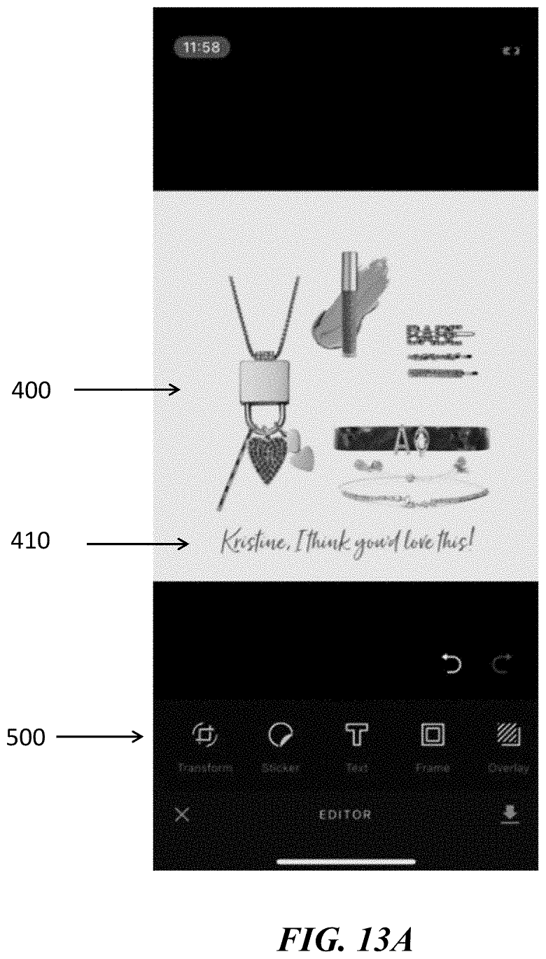

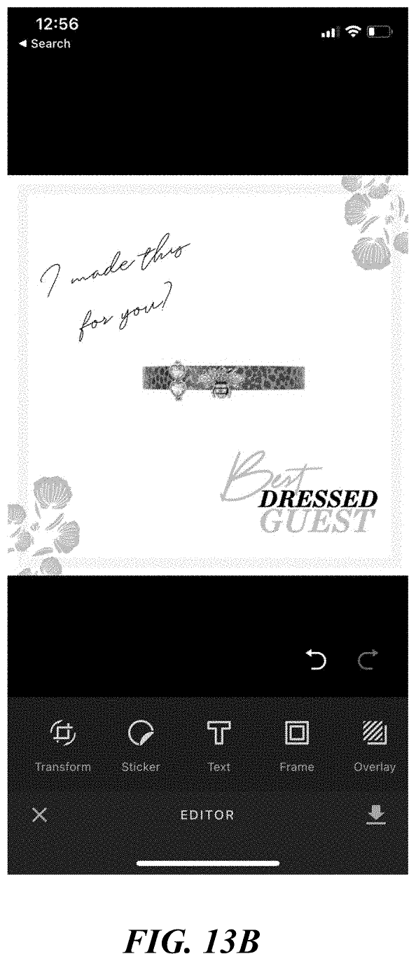

As illustrated in FIGS. 13A and 13B, the user interface may be configured to allow a user to visually customize an image of a saved look 400 before sharing the saved look 400. In some cases, the image of the saved look 400 may be visually customized by adding a string of text 410 to an image, a photograph, or a screen capture of the saved look 400. The string of text may be further modified by changing a size, position, an orientation, a font, or a color of the string of text 410 or a portion thereof. In some cases, the user interface may be configured to provide an editing panel 500 to aid a user in customizing the saved look 400. The editing panel 500 may comprise a transform icon, a sticker icon, a text icon, a frame icon, and/or an overlay icon. The transform icon may be configured to allow a user to transform (e.g., rotate, resize, and/or reposition) one or more items displayed within the saved look. The sticker icon may be configured to allow a user to add one or more stickers into a portion of the saved look. The text icon may be configured to allow a user to add a string of text 410 to the saved look 400. The frame icon may be configured to allow a user to add a frame around the saved look 400. The overlay icon may be configured to allow a user to overlay a first image onto a second image, or vice versa. At least one of the first image or the second image may comprise an image, a photograph, or a screen capture of the saved look 400.

Sharing Saved Looks

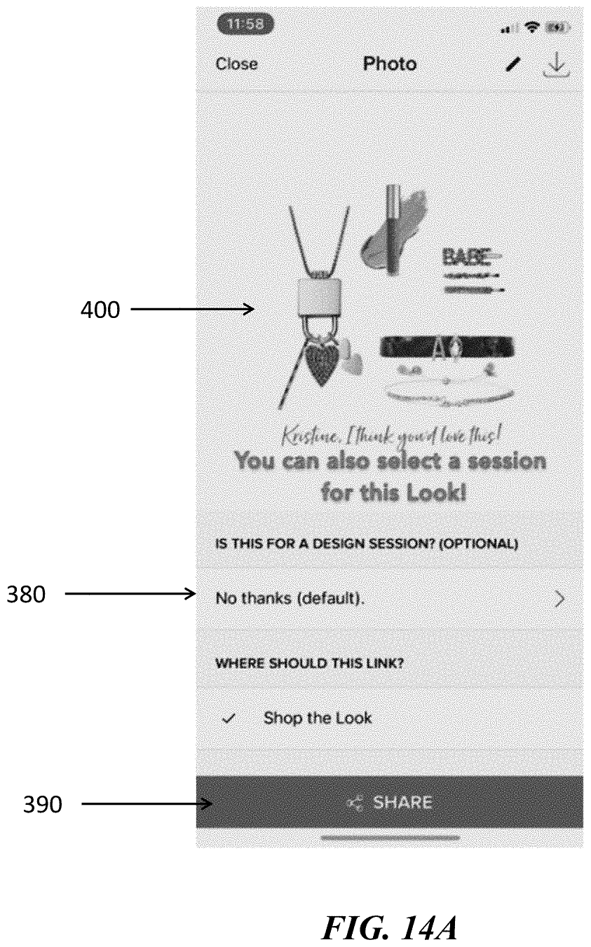

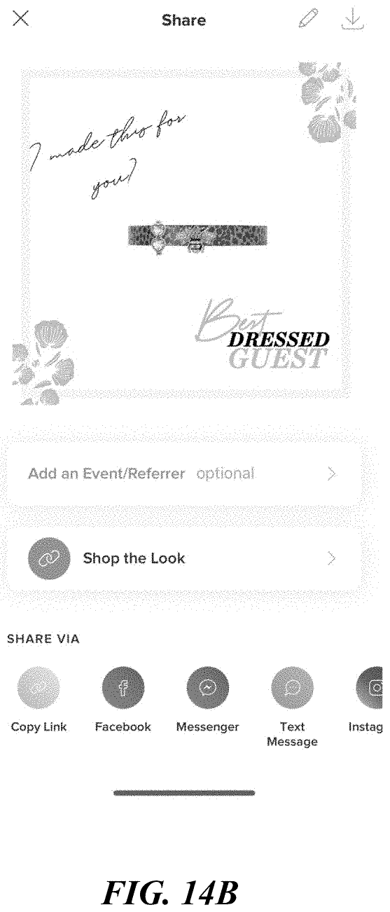

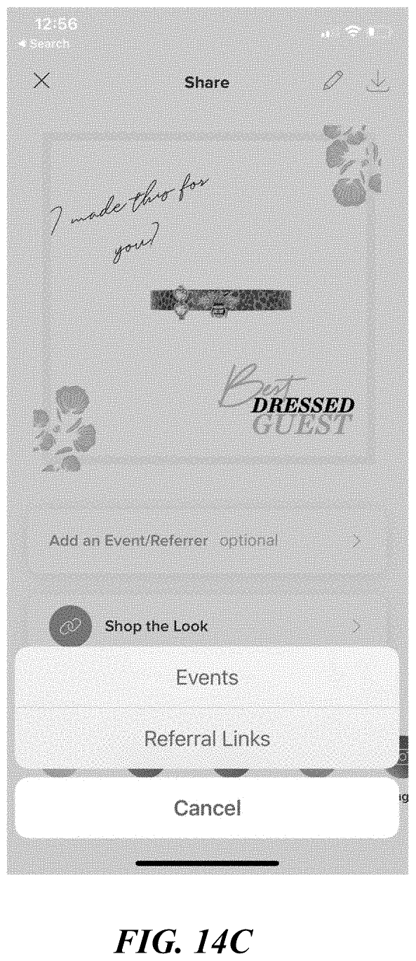

As shown in FIGS. 14A and 14B, once a user finishes customizing a saved look 400, the user interface may provide the user with a design session button 380 and a share button 390. The design session button 380 may allow a user to add the saved look 400 to a design session (i.e., an online or digital trunk show). As used herein, a “design session” may be referred to interchangeably as a “trunk show,” an “online trunk show,” a “digital trunk show,” an “event,” or a “virtual trunk show.” The share button 390 may allow a user to share the saved look 400 via a link, text message, or various social media platforms. The user interface may also permit the user to shop the look. As shown in FIG. 14C, in some cases the user interface may provide the user with the option to associate the saved look with one or more events, and to create one or more referral links associated with the saved look.

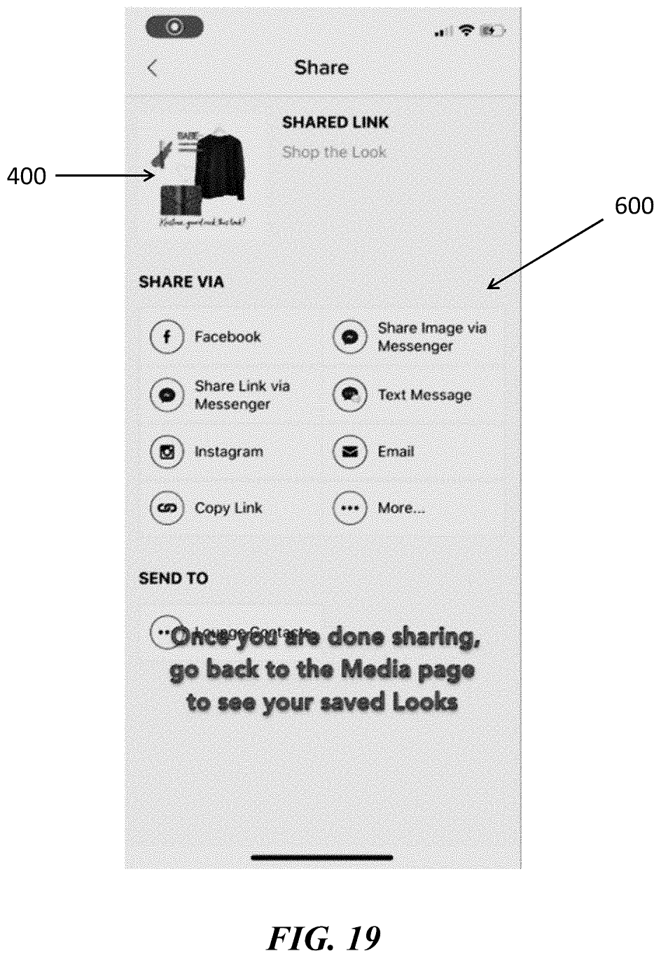

As shown in FIG. 19, the user interface may be configured to provide a user with a plurality of methods for sharing a saved look 400. The plurality of sharing methods may be configured to permit sharing of the saved look 400 via one or more social media platforms. The one or more social media platforms may include, for example, Facebook™, Messenger™, and/or Instagram™. The saved look 400 may be shared as an image and/or a link that permits consumers to access the shared look and shop the one or more items within the shared look. In some cases, the image and/or the link may be configured to direct a recipient of a shared look to a stylist's online or digital trunk show. The recipient may view and shop for the one or more items in the shared look from within the stylist's online trunk show. In some cases, the plurality of sharing methods may be configured to permit sharing of the saved look 400 via a text message, an email, and/or a direct link. The direct link may be configured to direct a recipient of a shared look to a stylist's online or digital trunk show that is linked to the shared look. The recipient may view and shop for the one or more items in the shared look from within the stylist's online trunk show.

Referring back to FIGS. 14A and 14B, when a user presses the share button 390, the user interface may be configured to allow a user to share one or more saved looks 400 with a third party. The third party may comprise another user or another consumer. As described above, the one or more saved looks may be shared via a messaging application, an email, a text, a link, or a social media platform. As described elsewhere herein, in some cases the one or more saved looks may be generated by a stylist, and/or an algorithm. In such cases, the one or more saved looks may be shared with a consumer, another stylist, and/or another user.

When a user presses the share button 390 to share a saved look 400, the user interface may be configured to allow a user to choose a recipient of the saved and shared look. The recipient may comprise a stylist, a consumer, or another user. In some cases, the user interface may be configured to provide a user with a customer list from which the user may select a desired recipient or a previous customer. In other cases, the user interface may be configured to allow a user to send the saved look 400 to a new customer. When a saved look 400 is shared with a recipient using the one or more sharing methods disclosed herein, the saved look may be referred to as a shared look. As used herein, a shared look may refer to a saved look that has been shared with and/or distributed to one or more recipients using any one or more methods of sharing disclosed herein.

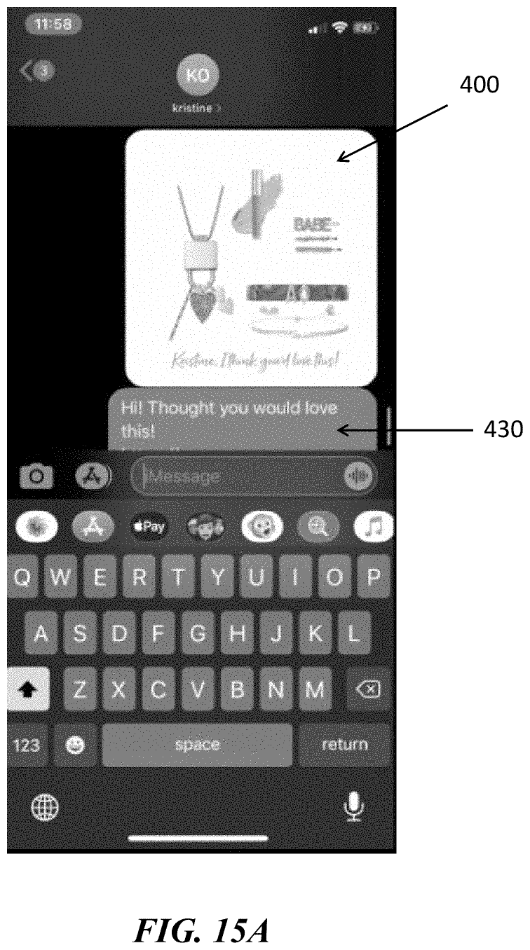

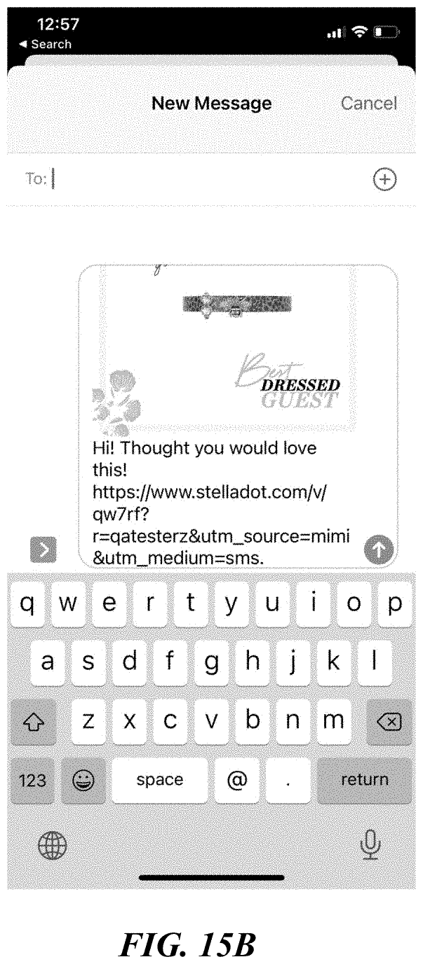

As shown in FIGS. 15A and 15B, in some exemplary cases, a user may share a saved look 400 through a text message. The text message may comprise a link that is provided with the text of the text message. The link may direct a recipient (e.g., a consumer) to a digital trunk show through which the recipient may view the shared look and the one or more items within the shared look. The text message may comprise a personalized text message 430 that accompanies the saved look 400. A recipient of the shared look may click on an image of the saved look 400 that is displayed on a device of the recipient. Upon clicking the image of the saved look 400, the recipient may view an enlarged version of the saved look 400. In some cases, the recipient may click on the link provided with the text message. Upon clicking the link, the recipient may be directed to a digital trunk show of the stylist who shared the saved look 400 with the recipient. The recipient may view the saved look 400 or modify and/or purchase the one or more items within the saved look 400 through the digital trunk show.

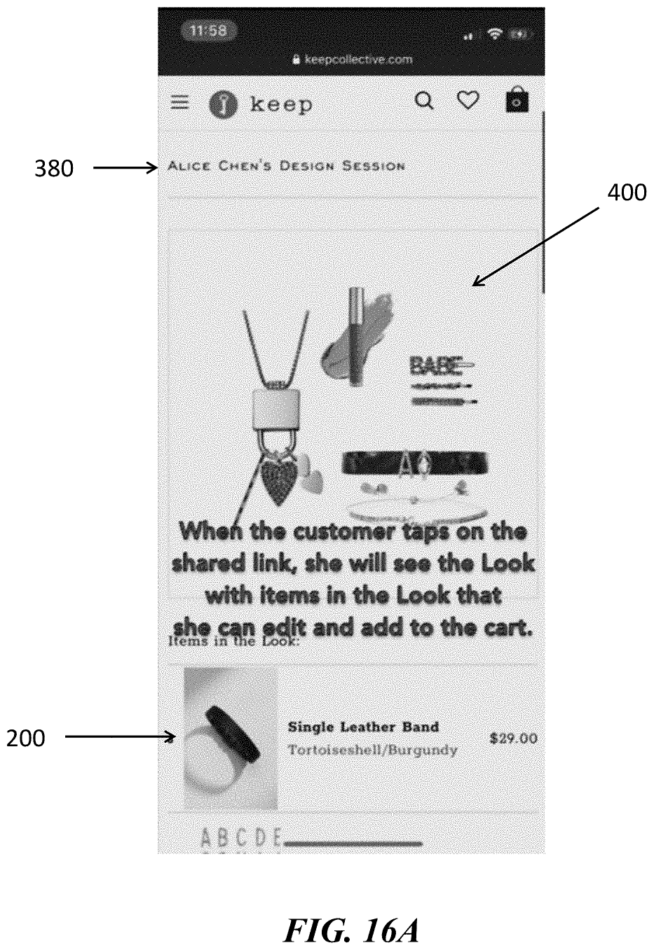

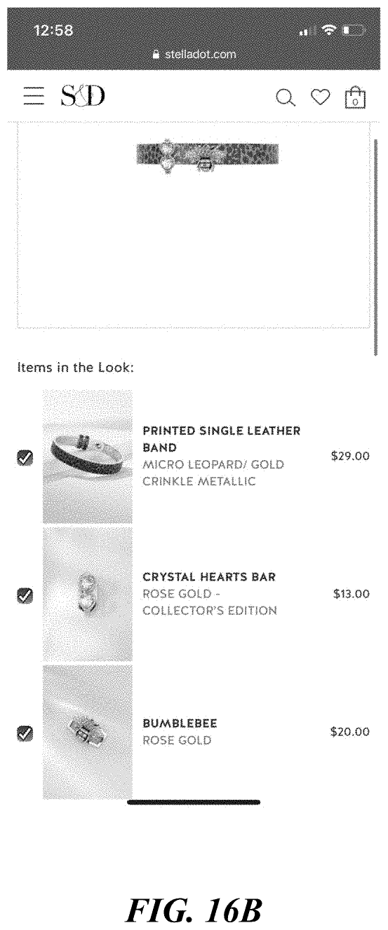

As described elsewhere herein, a stylist may attach her trunk show link to a saved look for sharing with a recipient. A recipient of the shared look may view the shared look along with the one or more items within the shared look from within a website or a webpage of the stylist's online or digital trunk show. As shown in FIGS. 16A and 16B, in some cases, the recipient may be directed to a website or a webpage of the stylist's online or digital trunk show 380 after clicking on the link provided with the text message. The online or digital trunk show 380 may be configured to display the saved look 400 along with a list of the items within the saved look 400. The list of items may comprise a listing of one or more items of interest 200 selected by a curator or a stylist. The list of items may be positioned adjacent to (e.g., above, below, to the right of, to the left of, or next to) a virtual canvas comprising the one or more items of the saved look 400. The list of items may comprise a listing of one or more items of interest 200 selected by a stylist or an algorithm. The list of items may correspond to the one or more items or item combinations shown within a saved or shared look.

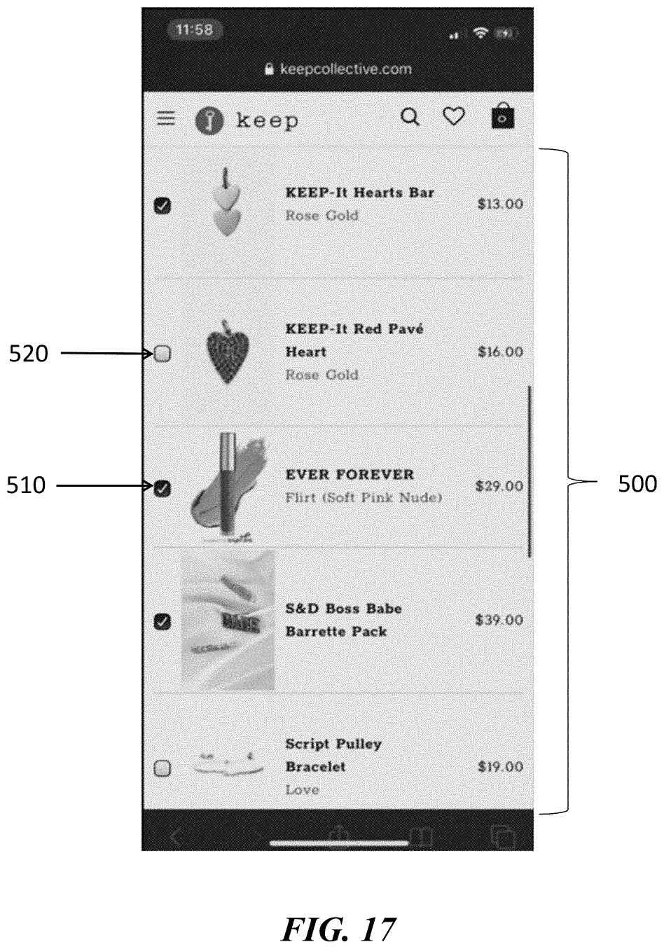

FIG. 17 illustrates a list of items 500 corresponding to one or more items associated with a saved or shared look. The list of items 500 may comprise a listing of each item within the saved or shared look. The list of items 500 may comprise a plurality of boxes corresponding to each item within the saved or shared look. Each of the plurality of boxes may be checked and/or unchecked by a user or a recipient of the saved or shared look. In some cases, one or more boxes of the plurality of boxes may be checked by a user to add the one or more checked items to a shopping cart for purchasing. In some cases, one or more boxes of the plurality of boxes may be checked to indicate that a viewer of the saved look is interested in purchasing the item. In any of the embodiments described herein, the user interface may be configured to display a checked box 510 indicating that the user or recipient of the saved or shared look has designated an item of interest as a desired item (i.e., an item that the user or recipient is interested in purchasing). A desired item may correspond to an item that the user or the recipient is interested in purchasing. In other cases, one or more boxes of the plurality of boxes may be unchecked to indicate that a viewer of the saved look is not interested in the item. In such cases, the user interface may be configured to display an unchecked box 520 indicating that the user or recipient of the saved or shared look has not designated the item of interest as a desired item. In some cases, the list of items 500 may be configured to display a total price associated with one or more desired items selected by the user or the recipient for purchasing. The total price may be determined based on individual pricing information associated with each of the one or more desired items selected for purchasing. In some cases, the total price may be determined by adding together individual prices associated with each of the one or more desired items selected for purchasing.

Modifying Items within a Shared Look

In some cases, when a saved look is shared, a recipient (e.g., a user or a consumer) of the shared look may view and/or modify one or more items within the shared look. Modifying the saved look may involve adding, removing, modifying (e.g., by adjusting a color, a size, a style, or another visual or physical characteristic of), and/or exchanging one or more components, products, or items (e.g., articles of clothing and/or fashion accessories) of a saved look. In some cases, the recipient (e.g., a user or a consumer) of the shared look may select one or more items within the shared look for purchasing. In some cases, the recipient (e.g., a user or a consumer) of the shared look may modify the one or more items (e.g., by changing a color, a size, or a style of the one or more items) before purchasing the one or more items. In some cases, the recipient may view a list of items corresponding to the one or more items in the shared look. In some cases, the recipient may check and/or uncheck one or more items within the list of items to indicate a selection of items that the recipient would like to purchase.

In some cases, a recipient of a shared or saved look (e.g., a consumer) may add, remove, modify, and/or exchange one or more components, products, or items (e.g., articles of clothing and/or fashion accessories) of the shared or saved look. Modifying one or more items in a shared look may comprise adjusting a size, a color, and/or a style of the one or more items. For example, if the shared look comprises an article of clothing (e.g., a top), a consumer may modify a size, a color, and/or a design of the top. Alternatively, the consumer may exchange the top for another article of clothing (e.g., another top) with a different size, a different color, and/or a different design. In another example, if the shared look comprises a base piece (e.g., a bracelet) with a plurality of customizable attachments (e.g., charms), the consumer may change a size, a color, and/or a design of the bracelet, add additional charms, remove at least one of the charms, rearrange the charms in a different order or configuration, or modify a size, a color, and/or a design of at least one of the charms. In another example, if the shared look comprises a base piece (e.g., a necklace) with a plurality of charms, the consumer may change a size, a color, and/or a design of the necklace, add additional charms, remove at least one of the charms, rearrange the charms in a different order or configuration, or modify a size, a color, and/or a design of at least one of the charms. In some cases, the consumer may view a list of items corresponding to the one or more items in the saved look. The one or more items in the list of items may or may not correspond to one or more items modified by the consumer. In some cases, the consumer may check and/or uncheck one or more items within the list of items to indicate a selection of items that the consumer would like to purchase.

As described above, the systems and methods disclosed herein may be configured to allow a recipient (e.g., a user or a consumer) of a shared look to view and/or modify one or more items within the shared look. Allowing a consumer to modify the one or more items within the shared look may provide several benefits to a consumer. For example, the consumer may be able to adjust the look or the items within the look to better conform with the consumer's personal style, preferences, or mood. In another example, the consumer may be able to adjust the look or the items within the look to design a fashionable appearance that is more appropriate for a certain environment, venue, occasion, event, or setting. In another example, the consumer may be able to critique and/or provide feedback to a stylist who curated the look or the items within the look so that the stylist may curate similar items or looks in the future based on how the consumer modifies the one or more items within the shared look. In another example, the consumer may be able to provide the stylist who curated the look or the items within the look with a more accurate assessment of the consumer's personal style or preferences, based on how the consumer modifies the one or more items in the shared look. In another example, the consumer may be able to use the look curated by a stylist as a starting point or a point of inspiration to create another look that matches the consumer's personal style or preferences, thereby reducing a time or an effort required by the consumer to find and/or select one or more items of interest to create a desired look.

When a user or a recipient modifies a shared look, the list of items associated with the shared look may be updated accordingly to account for a user's or recipient's addition, removal, or modification of one or more items or item combinations within the shared look. The updated list of items may comprise a plurality of boxes that may be checked and/or unchecked by a user or a recipient of the saved or shared look to indicate which items the user or recipient would like to purchase, and which items the user or recipient is not interested in purchasing.

As described above, the recipient of a saved or shared look (e.g., a consumer) may view one or more items of interest and/or one or more item combinations within the saved and shared look. The one or more items of interest and/or the one or more item combinations within the saved or shared look may be curated by a user or a stylist. The recipient may further modify, customize, add, exchange, and/or remove one or more individual items within a look before purchasing a desired set, combination, or subset of items within the look. After the recipient modifies, customizes, adds, exchanges, and/or removes one or more individual items within a look, the user interface may be configured to provide the recipient with an updated list corresponding to the one or more individual items displayed in the modified shared look. In some cases, the updated list may be configured to display an updated total price associated with one or more desired items selected by the user or the recipient for purchasing.

Purchasing Shared Looks

As described elsewhere herein, the methods and systems of the present disclosure may allow a user or a recipient of a shared look to view a list of the items corresponding to the one or more items within the shared look. The list of items may comprise an array of checkboxes for each item in the look. The user interface may be configured to allow a user or a recipient to select one or more items within the list of items for purchasing.

In some cases, the one or more items within a shared look may be modified by a user or a recipient of the shared look. Modifying the one or more items within the shared look may comprise adding, removing, customizing, modifying, and/or exchanging one or more items within the shared look. In some embodiments, the list of items associated with the shared look may be updated based on one or more modifications performed by the user or the recipient of the shared look. The updated list of items may be configured to display an updated total price for the modified shared look, in part based on one or more modifications made to the shared look.

In some embodiments, the user interface may be configured to allow a user or a recipient of a shared look to select one or more items from the list of items for purchasing. The user or the recipient of the shared look may select one or more items for purchasing by checking and/or unchecking one or more boxes associated with the one or more items within the shared look. In some cases, the user or the recipient of the shared look may wish to modify the shared look before selecting one or more items for purchase. In such cases, the list of items may be updated based on one or more modifications to the shared look. The user interface may then be configured to allow a user or a recipient to select one or more items within the modified look for purchasing. The user may select one or more items within the modified look for purchasing by checking or unchecking one or more items within the updated list of items corresponding to the modified look.

In any of the embodiments described herein, the list of items corresponding to the one or more items within a shared look may be configured to display pricing information for the items in the look. The pricing information may be updated based on the items that are checked or unchecked by the recipient of the shared look. The pricing information may be updated in real-time based on which items are selected or not selected by the recipient.

In some embodiments, when a user or a recipient modifies a shared look, an updated list of items corresponding to the modified shared look may be configured to display pricing information for the items in the modified shared look. The pricing information may be updated based on the one or more items within the modified shared look that are selected (i.e., checked or unchecked) for purchasing. The pricing information may be updated in real-time based on which items are selected or not selected by a user or a recipient.

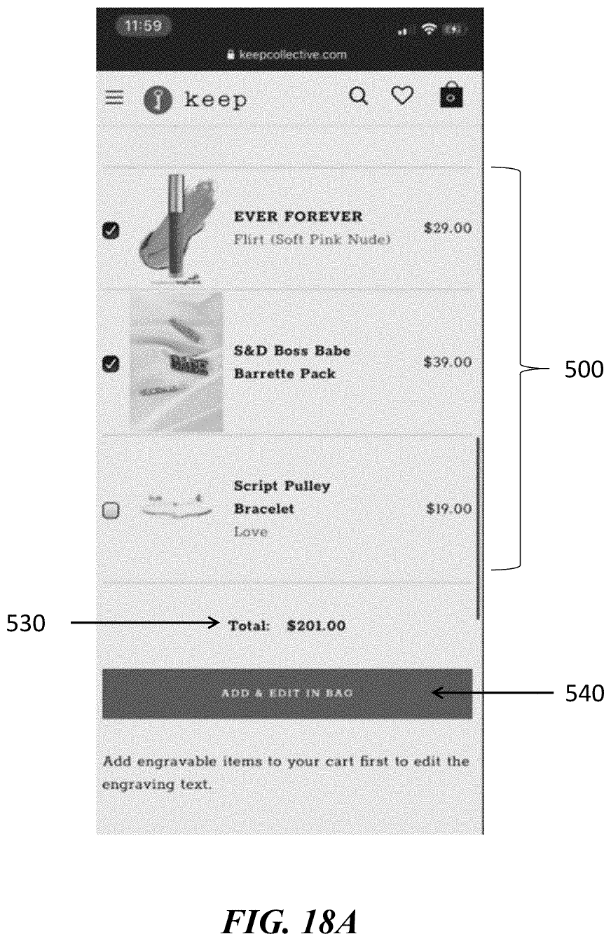

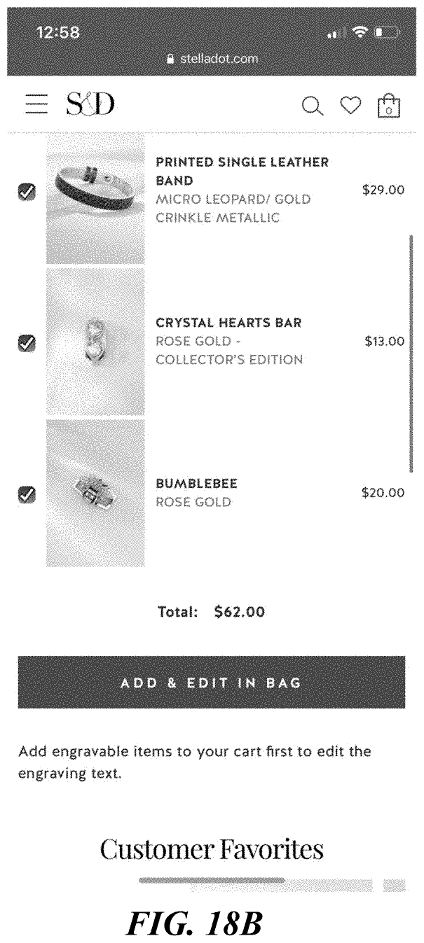

As shown in FIGS. 18A and 18B, the list of items 500 may be configured as a purchase list. The purchase list may be configured to compute a total price 530 based on which boxes are checked and which boxes are unchecked. The purchase list may be configured to compute a total price 530 based on which items within a shared look or a modified shared look are selected for purchasing. The total price 530 may be adjusted and/or updated based on a user's or recipient's selection of at least a subset of the items shown in the list of items 500. In some cases, the list of items 500 may comprise an updated list of items generated based on one or more modifications made to a shared look. The user interface may be further configured to provide a user or a recipient of a shared look with an add/edit in bag button 540. The add/edit in bag button 540 may be configured to add the one or more selected items into a virtual cart for the user or the recipient to purchase.

In some embodiments, a shared look may be configured to provide a recipient of the shared look with a customer purchase path. The customer purchase path may be configured to allow a user or a recipient to view the one or more items or products within the shared look. The customer purchase path may be configured to allow a user or a recipient to view pricing information associated with (i) the shared look or (ii) the one or more items or products within the shared look. The customer purchase path may be configured to allow a user to select at least one or more items or products within a shared look or a modified shared look. The pricing information associated with the shared look, the modified shared look, or the one or more items or products within the shared look or the modified shared look may be updated based on a user's or a recipient's selection of one or more items or products within the shared look or the modified shared look. The user's or recipient's selection of the one or more items or products may correspond to a subset of the items or products originally shown within a saved look, a shared look, or a modified shared look.

Sharing Looks

As shown in FIG. 19, a saved look 400 may be shared via one or more sharing methods 600. The one or more sharing methods 600 may be configured to permit sharing of the saved look 400 via one or more social media platforms. In some cases, the one or more sharing methods 600 may be configured to permit sharing of the saved look 400 via a text message, an email, or a link.

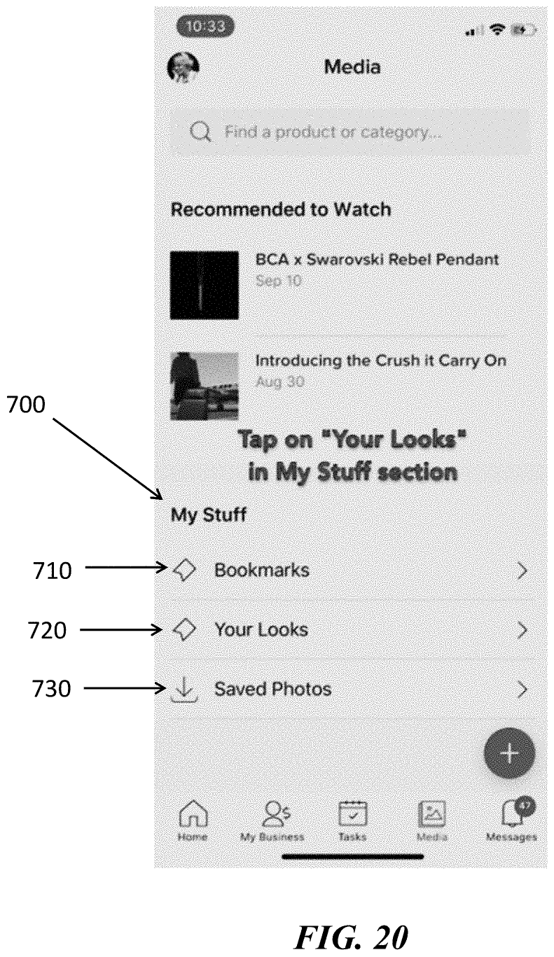

Once a saved look 400 is shared (e.g., by a stylist), a user (e.g., a consumer) may utilize the user interface to access the shared look 400 through a media tab provided within the user interface. As shown in FIG. 20, the media tab may be configured to display a “My Stuff” tab 700. The “My Stuff” tab 700 may comprise one or more interactive elements that may be configured to direct the user to a bookmarks tab 710, a saved looks tab 720, and a saved photos tab 730. The bookmarks tab 710 may be configured to display one or more looks and/or one or more items selected or saved by a user for future browsing. The saved looks tab 720 may be configured to display one or more saved looks generated and saved by a user (e.g., a consumer and/or a stylist). The saved photos tab 730 may be configured to display one or more photos, images, or screenshots of saved looks and/or bookmarked items.

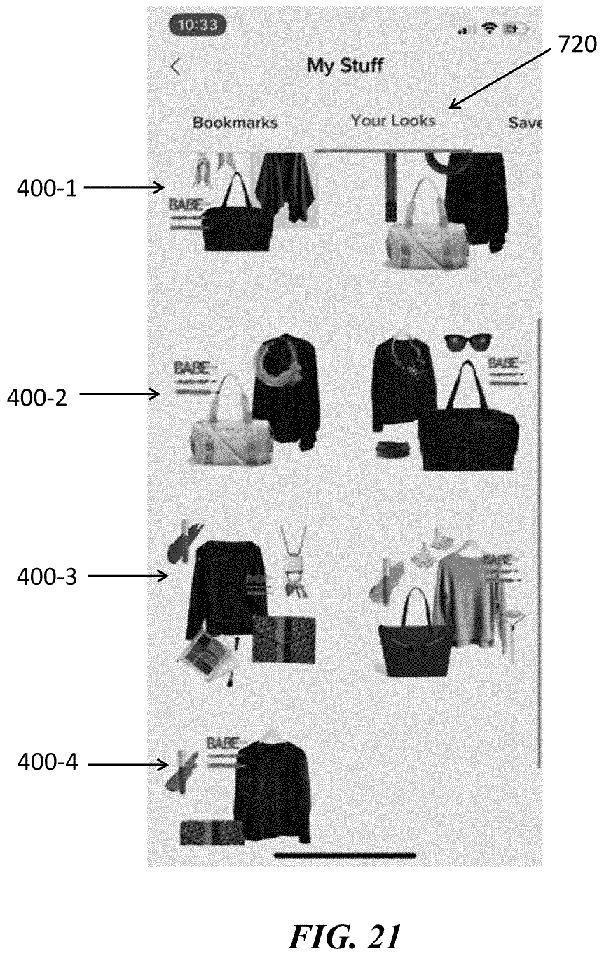

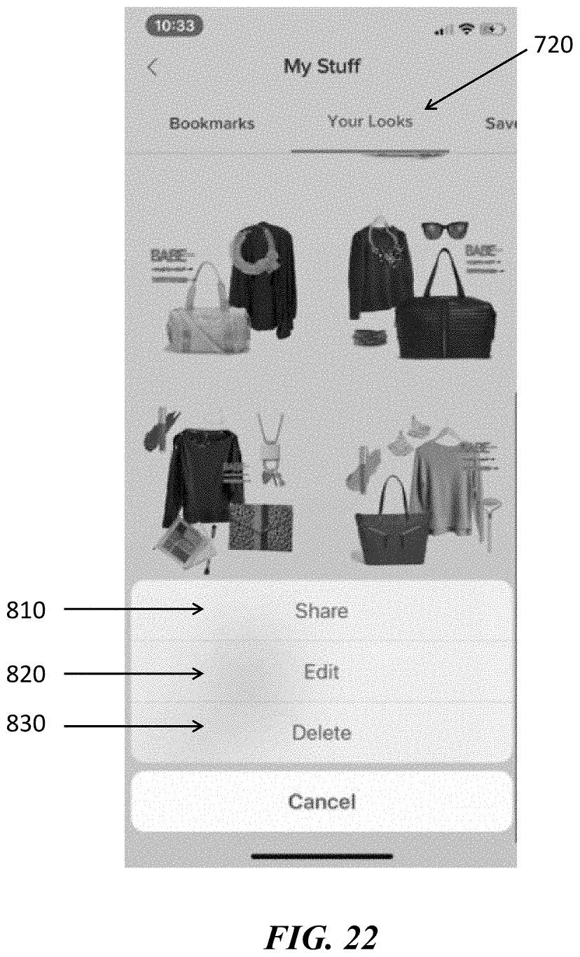

FIG. 21 illustrates a layout of the user interface when a user selects the saved looks tab 720. The saved looks tab 720 may be configured to display a plurality of saved looks 400-1, 400-2, 400-3, 400-4, and so on. As shown in FIG. 22, each of the plurality of saved looks may be selected for sharing 810, editing 820, and/or deletion 830. As described elsewhere herein, editing a saved look may involve adding, deleting, and/or rearranging one or more items or accessories within the save look. Deleting may involve removing one or more items from the saved look. In some cases, editing one or more items within a saved look may involve adding, removing, customizing (e.g., changing a size, a color, and/or a style of), and/or exchanging one or more items within the saved look. Once one or more items are added to a virtual canvas, they may be rearranged, resized, and/or combined with other items or accessories by positioning the added item over another item currently displayed on the virtual canvas.

In some cases, the one or more saved looks displayed within the saved looks tab may be selected for purchasing. In some cases, at least a subset of the one or more items within a saved look or a modified saved look displayed within the saved looks tab may be selected for purchasing. The one or more saved looks may be edited before purchasing. The one or more saved looks may be edited by a user (e.g., a consumer and/or a stylist).

Trunk Show Link

In another aspect, the present disclosure provides methods and systems for viewing and/or sharing looks through a digital or virtual trunk show. A digital trunk show may be a stylist's online website for consumers to shop from. The digital or virtual trunk show may comprise a digital or virtual arrangement of one or more items (e.g., one or more articles of clothing and/or one or more fashion accessories). The digital trunk show may be accessed using a digital trunk show link. The digital trunk show link may comprise a link that is configured to direct a consumer to a webpage or a website of a stylist's digital trunk show when pressed. Sharing a look through a link to a digital trunk show may allow consumers to open and view the shared look and the items in the look, all within a webpage on which or through which the stylist's online trunk show is displayed or accessed. The look may be created by a stylist based on a consumer's preferences or past selection of items. The one or more items within a look may be curated by a stylist based on a consumer's preferences or past selection of items.

In some cases, the digital or virtual trunk show may be configured to allow a consumer to try a shared look or to view the shared look and the items in the shared look from within the stylist's online trunk show site. Trying a look may involve digitally arranging one or more items within a look to visually approximate a relative arrangement of the one or more items when the one or more items are worn by a consumer or placed on a body of the consumer. In some cases, trying a look may involve placing the one or more items of a look onto a digital avatar of a consumer. The digital avatar may be generated based on one or more measurements of a body or a body part of the consumer. The digital avatar may be configured to approximate a relative size and/or a relative shape of one or more parts of a consumer's body (e.g., a head, a neck, a shoulder, a chest, an arm, a torso, a hip, a waist, a leg, or a foot of a consumer). The digital or virtual trunk show may be configured to arrange the one or more items of a look on the digital avatar of the consumer to provide a consumer with a visual approximation of the look if the consumer were to purchase and wear the one or more items of the look in real life.

A user (e.g., a consumer) may access the digital or virtual trunk show via a trunk show link. A trunk show link may be a virtual element that is displayable on a device of a user (e.g., a stylist or a consumer). The trunk show link may be configured to link and/or direct a user to a webpage that is configured to display all of the products that are sold in the trunk show, and the consumer may land on a page with the look that the stylist had shared along with the items within the shared look. The trunk show link may be a link that is generated by a stylist. The trunk show link may be provided to a consumer so that the consumer may view and/or modify the items within the look through the stylist's online trunk show webpage. The digital trunk show may provide a user interface for a user to view, browse through, and purchase curated items. Attaching a trunk show link associated with the stylist's online or digital trunk show to a shared look may allow a user to (i) access the stylist's online or digital trunk show, and (ii) modify one or more shared looks from within the online or digital trunk show by adding or removing one or more items within the one or more shared looks. The trunk show link may be shared with a consumer using any one or more sharing methods disclosed herein.

In some embodiments, the trunk show link may comprise a hyperlink. A hyperlink may comprise text that is configured to direct a user (e.g., a consumer or a recipient of a trunk show link) to a web page or a web portal comprising one or more items or looks when the user highlights, taps, presses, hovers over, and/or clicks on the hyperlink or a portion thereof. The hyperlink may be shared using any one or more sharing methods disclosed herein. The hyperlink may be configured to display on a device of a user or a recipient of the hyperlink. The device may comprise a mobile phone, a smartphone, a laptop computer, a desktop computer, or any other electronic device described above. The hyperlink may be copied and shared via a web browser, a web page, and/or a messaging interface that is displayed on a device of a user or a recipient of the hyperlink. In some cases, the hyperlink may be configured to direct a user or a recipient of the hyperlink to another web page comprising the digital or virtual trunk show.

In some cases, the trunk show link may comprise an embedded text link. The embedded text link may comprise a string of text. The embedded text link and/or the string of text associated with the embedded text link may be configured to direct a user to the digital or virtual trunk show when the user interacts with (e.g., clicks on) the embedded text link.

In some cases, the trunk show link may comprise an embedded image link. The embedded image link may comprise an image. The image may be configured to direct a user to the digital or virtual trunk show when the user interacts with (e.g., clicks on) the embedded text link.

In some cases, the trunk show link may comprise a scannable element that is configured to direct a user to one or more digital or virtual trunk shows when the user scans the scannable element. The scannable element may comprise a barcode or a Quick Response (QR) code. The scannable element may be scanned using an camera, an imaging device, or any scanning device configured to illuminate the scannable element with a light and detect at least a portion of light that is reflected back towards an imaging sensor of the scanning device.

Item Bundles

In another aspect, the present disclosure provides methods and systems for creating looks using product bundles or a bundle of items. The bundle of items may comprise one or more items that are sold as a bundle. Every bundle may comprise one or more items that can be customized, such as engravable items, or items having one or more variations in style, size, color, and/or material that a consumer may choose from.

The bundle of items may be added to a look by a stylist. The bundle of items may comprise a combination of items with a modified pricing when added together. For example, the individual items within the combination of items may have an initial total price that may be computed by adding together the individual prices of each individual item. When the individual items are combined and/or bundled together to create a combination of items or a bundle of items, the combination or bundle of items may have an adjusted total price. In some cases, the adjusted total price may be less than the initial total price.

In some cases, a stylist may use one or more user interfaces described herein to create a look using one or more product bundles or bundles of items. The combination or bundle of items may comprise a predetermined selection of items. Some items within the bundle of items may require customization. The predetermined selection of items may comprise a predetermined number of items and/or a selection of two or more items within a predetermined product category. The predetermined selection of items may comprise a predetermined combination of two or more items. The predetermined combination of two or more items may comprise a first item and a second item. The second item may be different than the first item. The first item and the second item may comprise different portions of a look. The second item may be compatible (e.g., with respect to size, shape, and/or theme) with the first item such that the second item may be combined with or attached to the first item. In some cases, the predetermined combination of two or more items may comprise a combination of a first item with a set of matching items and/or matching accessories. The matching items and/or the matching accessories may be compatible with the first item with respect to size, shape, and/or theme. In one example, the first item may comprise a necklace, and the matching items and/or matching accessories may comprise a plurality of charms that may be attached to or suspended from the necklace. In another example, the first item may comprise a bracelet, and the matching items and/or matching accessories may comprise a plurality of customizable accessories (e.g., one or more charms, stones, fashion accessories, etc.) that are configured to attach to the bracelet. In some cases, the first item may comprise a first article of clothing or a first fashion accessory, and the second item may comprise a second article of clothing or a second fashion accessory that is configured to match with the first article of clothing or the first fashion accessory. In some cases, the first item may comprise a first article of clothing or a first fashion accessory, and the matching items and/or matching accessories may comprise one or more articles of clothing or one or more fashion accessories that are configured to match with the first article of clothing or the first fashion accessory. In any of the embodiments described herein, when a stylist creates a look with bundles, the stylist can customize the bundle by selecting one or more variations of the items in the bundle that require customization. The one or more variations may comprise variations in sizes, colors, styles, materials, or any other visual or physical characteristic that may be customized for a particular item.

After a stylist selects a plurality of items comprising a predetermined selection of items in a bundle, the one or more user interfaces disclosed herein may be configured to allow the stylist to recommend and/or share the bundle of items as part of a look. The bundle of items may be shared with an individual who is not the stylist (e.g., a consumer) using any one or more sharing methods disclosed above. In some cases, the bundle of items may be shared as part of a look via a hyperlink or an embedded link, as described elsewhere herein. The bundle of items may be shared with a recipient as part of a shared look. The recipient may comprise a consumer who may be interested in viewing, modifying, and/or purchasing the bundle of items within the shared look together as a set.

In some cases, the one or more user interfaces described herein may be configured to allow a recipient of the shared bundle of items to modify the bundle of items. Modifying a bundle of items may comprise adding, removing, and/or exchanging one or more items within the bundle. In some cases, modifying the bundle of items may involve changing the engraved text on one or more items within the bundle, and/or selecting other variations of the one or more items within the bundle. The recipient may modify and/or customize the one or more items within the bundle once the recipient adds the shared bundle of items within the shared look into their shopping cart. From the shopping cart, the recipient can make one or more modifications to the bundle before purchasing the bundle. The recipient can uncheck the bundle from the shared look if they do not want to add the bundle to their shopping cart to purchase. In some cases, modifying the bundle of items may result in an adjustment to a pricing of the bundle of items. For example, if a user removes a certain item and/or changes a combination of items, the price of the bundle may be adjusted (e.g., increased or decreased). In some cases, if a user adds an item that is incompatible with the bundle, the user interface may be configured to prompt the user to remove the item or modify other items in the bundle to receive a discounted or adjusted price. In other cases, if a user adds or exchanges an item that is compatible with the one or more items in the bundle, the price of the bundle of items may remain unchanged (e.g., discounted). Alternatively, if a user removes an item that is compatible with the one or more items in the bundle, the user interface may be configured to prompt the user to add another compatible item in order to receive a discounted or adjusted price for the bundle of items.

Computer Systems

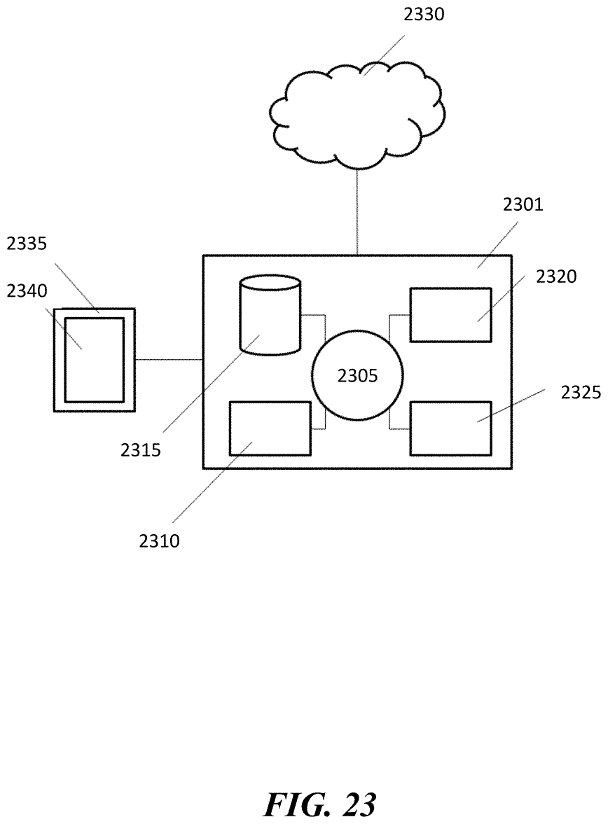

Another aspect of the present disclosure provides computer systems that are programmed or otherwise configured to implement methods of the disclosure. FIG. 23 shows a computer system 2301 that is programmed or otherwise configured to implement a method for managing digital looks. The computer system 2301 can control the generation and/or operation of a user interface to allow a stylist to create, modify, customize, view, try, and/or share one or more looks. The computer system 2301 can control the generation and/or operation of a user interface to allow a user to search for, view, select, modify, customize, arrange, and/or combine one or more items in order to create a look. The computer system 2301 can control the generation and/or operation of a user interface to allow a user to modify, customize, arrange, and/or combine one or more items within a virtual canvas in order to create a look. The computer system 2301 can be an electronic device of a user or a computer system that is remotely located with respect to the electronic device. The electronic device can be a mobile electronic device.

The computer system 2301 may include a central processing unit (CPU, also “processor” and “computer processor” herein) 2305, which can be a single core or multi core processor, or a plurality of processors for parallel processing. The computer system 2301 also includes memory or memory location 2310 (e.g., random-access memory, read-only memory, flash memory), electronic storage unit 2315 (e.g., hard disk), communication interface 2320 (e.g., network adapter) for communicating with one or more other systems, and peripheral devices 2325, such as cache, other memory, data storage and/or electronic display adapters. The memory 2310, storage unit 2315, interface 2320 and peripheral devices 2325 are in communication with the CPU 2305 through a communication bus (solid lines), such as a motherboard. The storage unit 2315 can be a data storage unit (or data repository) for storing data. The computer system 2301 can be operatively coupled to a computer network (“network”) 2330 with the aid of the communication interface 2320. The network 2330 can be the Internet, an internet and/or extranet, or an intranet and/or extranet that is in communication with the Internet. The network 2330 in some cases is a telecommunication and/or data network. The network 2330 can include one or more computer servers, which can enable distributed computing, such as cloud computing. The network 2330, in some cases with the aid of the computer system 2301, can implement a peer-to-peer network, which may enable devices coupled to the computer system 2301 to behave as a client or a server.

The CPU 2305 can execute a sequence of machine-readable instructions, which can be embodied in a program or software. The instructions may be stored in a memory location, such as the memory 2310. The instructions can be directed to the CPU 2305, which can subsequently program or otherwise configure the CPU 2305 to implement methods of the present disclosure. Examples of operations performed by the CPU 2305 can include fetch, decode, execute, and writeback.

The CPU 2305 can be part of a circuit, such as an integrated circuit. One or more other components of the system 2301 can be included in the circuit. In some cases, the circuit is an application specific integrated circuit (ASIC).

The storage unit 2315 can store files, such as drivers, libraries and saved programs. The storage unit 2315 can store user data, e.g., user preferences and user programs. The computer system 2301 in some cases can include one or more additional data storage units that are external to the computer system 2301, such as located on a remote server that is in communication with the computer system 2301 through an intranet or the Internet.

The computer system 2301 can communicate with one or more remote computer systems through the network 2330. For instance, the computer system 2301 can communicate with a remote computer system of a user (e.g., an end user, a consumer, a potential consumer, a stylist, a fashion designer, etc.). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 2301 via the network 2330.

Methods as described herein can be implemented by way of machine (e.g., computer processor) executable code stored on an electronic storage location of the computer system 2301, such as, for example, on the memory 2310 or electronic storage unit 2315. The machine executable or machine readable code can be provided in the form of software. During use, the code can be executed by the processor 2305. In some cases, the code can be retrieved from the storage unit 2315 and stored on the memory 2310 for ready access by the processor 2305. In some situations, the electronic storage unit 2315 can be precluded, and machine-executable instructions are stored on memory 2310.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 2301, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 2301 can include or be in communication with an electronic display 2335 that comprises a user interface (UI) 2340 for providing, for example, a portal for managing digital looks. A user can use the portal to create, modify, customize, view, try, and/or share one or more looks. In some cases, a user can use the portal to search for, view, select, modify, customize, arrange, and/or combine one or more items in order to create a look. The portal may be provided through an application programming interface (API). A user or entity can also interact with various elements in the portal via the UI. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 2305. The algorithm may be configured to provide a user (e.g., a stylist and/or a consumer) with access to a digital or virtual look, wherein the digital or virtual look comprises a virtual arrangement of one or more fashion articles selected by an algorithm or an individual who is not a consumer. The algorithm may be further configured to provide a user interface for the consumer to (i) view and modify the digital or virtual look and (ii) select one or more fashion articles within the digital or virtual look to purchase. In some cases, the algorithm may be configured to provide a user interface comprising a purchase list corresponding to the one or more fashion articles selected for purchasing. In some cases, the algorithm may be configured to provide a user interface for a user to create, modify, customize, view, try, and/or share one or more looks. In some cases, the algorithm may be configured to provide a user interface to allow a user to search for, view, select, modify, customize, arrange, and/or combine one or more items in order to create a look. In some cases, the algorithm may be configured to provide a user interface to allow a user to view, select, modify, customize, arrange, and/or combine one or more items in order to create a look.

In some embodiments, the algorithm may be configured to generate a digital look comprising one or more fashion articles based on a consumer preference, a consumer purchase history, a consumer profile, a consumer request, a consumer instruction, or one or more consumer responses to a questionnaire or survey. In some embodiments, the algorithm may be configured to aggregate a selection of one or more fashion articles for a digital look based on a consumer preference, a consumer purchase history, a consumer profile, a consumer request, a consumer instruction, or one or more consumer responses to a questionnaire or survey.

In some cases, the algorithm may be implemented using artificial intelligence and/or machine learning. For example, artificial intelligence, including one or more machine learning algorithms, may be employed to generate one or more digital looks or to aggregate a selection of one or more fashion articles for a digital look. The one or more machine learning algorithms may comprise a neural network. Examples of neural networks that may be used with embodiments herein may include a deep neural network (DNN), convolutional neural network (CNN), and recurrent neural network (RNN).

In some embodiments, the machine learning algorithm may be, for example, an unsupervised learning algorithm, a supervised learning algorithm, or a combination thereof. The unsupervised learning algorithm may utilize, for example, clustering, hierarchical clustering, k-means, mixture models, Density-based spatial clustering of applications with noise (DBSCAN), anomaly detection, local outlier factors, neural networks, autoencoders, deep belief nets, Hebbian learning, generative adversarial networks, self-organizing map, expectation-maximization algorithm (EM), method of moments, blind signal separation techniques, principal component analysis, independent component analysis, non-negative matrix factorization, singular value decomposition, or a combination thereof In some embodiments, the supervised learning algorithm may utilize, for example, support vector machines, linear regression, logistic regression, linear discriminant analysis, decision trees, k-nearest neighbor algorithm, neural networks, similarity learning, or a combination thereof.

In some embodiments, the machine learning algorithm may comprise a deep neural network (DNN). The deep neural network may comprise a convolutional neural network (CNN). The CNN may be, for example, U-Net, ImageNet, LeNet-5, AlexNet, ZFNet, GoogleNet, VGGNet, ResNet18 or ResNet, etc. Other neural networks may be, for example, deep feed forward neural network, recurrent neural network, LSTM (Long Short Term Memory), GRU (Gated Recurrent Unit), Auto Encoder, variational autoencoder, adversarial autoencoder, denoising auto encoder, sparse auto encoder, boltzmann machine, RBM (Restricted boltzmann machine), deep belief networks, generative adversarial networks (GAN), deep residual networks, capsule networks, or attention/transformer networks, etc. In some embodiments, the neural network may comprise neural network layers. The neural network may have at least about 2 to 1000 or more neural network layers. In some cases, the machine learning algorithm may utilize, for example, a random forest, a boosted decision tree, a classification tree, a regression tree, a bagging tree, a neural network, and/or a rotation forest.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for managing a digital look, the method comprising:
(a) providing a consumer with access to the digital look, wherein the digital look comprises a virtual arrangement of one or more tangible fashion articles selected by an algorithm or an individual who is not the consumer; and
(b) providing a user interface for the consumer to (i) view and modify the one or more tangible fashion articles in the digital look and (ii) select at least one or more tangible fashion articles to purchase, wherein the user interface is configured to provide the consumer with a purchase list corresponding to the one or more tangible fashion articles shown in the digital look.

2. The method of claim 1, wherein modifying the one or more fashion articles in the digital look comprises rearranging, add, removing, or customizing the one or more fashion articles associated with the digital look.

3. The method of claim 2, wherein customizing the one or more fashion articles comprises (i) modifying or altering a portion, a component, or a characteristic of the one or more fashion articles or (ii) interchanging the one or more fashion articles with another fashion article or a variant of the one or more fashion articles.

4. The method of claim 3, wherein the characteristic of the one or more fashion articles comprises a size, a color, a shape, or a style of the one or more fashion articles.

5. The method of claim 1, further comprising, prior to (a), generating the digital look using a digital canvas.

6. The method of claim 5, wherein generating the digital look comprises searching for one or more candidate fashion articles, selecting at least a subset of the one or more candidate fashion articles, and virtually arranging the at least the subset of the one or more candidate fashion articles on the digital canvas.

7. The method of claim 6, wherein the one or more candidate fashion articles are selected based on a consumer preference, a consumer purchase history, a consumer profile, a consumer request, a consumer instruction, or one or more consumer responses to a questionnaire or survey.

8. The method of claim 6, wherein virtually arranging the at least the subset of the one or more candidate fashion articles comprises resizing a virtual representation of a candidate fashion article.

9. The method of claim 6, wherein virtually arranging the at least the subset of the one or more candidate fashion articles comprises adjusting a position or an orientation of a virtual representation of a candidate fashion article.

10. The method of claim 6, wherein virtually arranging the at least the subset of the one or more candidate fashion articles comprises moving a virtual representation of a first candidate fashion article in front of or behind a virtual representation of a second candidate fashion article.

11. The method of claim 6, wherein virtually arranging the at least the subset of the one or more candidate fashion articles comprises combining two or more candidate fashion articles or overlaying a first candidate fashion article over a second candidate fashion article.

12. The method of claim 5, further comprising saving the digital look to a virtual library for sharing or customization at a later point in time.

13. The method of claim 12, further comprising (i) adding the saved digital look to a digital trunk show or design session or (ii) associating the saved digital look with the digital trunk show or design session.

14. The method of claim 1, wherein providing access to the digital look comprises sharing the digital look with the consumer via a trunk show link configured to direct a user to a digital trunk show or design session comprising the digital look.

15. The method of claim 14, wherein sharing the digital look with the consumer comprises attaching the trunk show link to a saved digital look.

16. The method of claim 14, wherein the trunk show link comprises a hyperlink, an embedded text link, an embedded image link, or a scannable element.

17. The method of claim 16, wherein the scannable element comprises a barcode or a Quick Response (QR) code.

18. The method of claim 1, wherein the user interface is configured to update the purchase list or an item pricing in real time based on (i) the consumer's selection of the one or more fashion articles for purchasing or (ii) the consumer's modification or customization of the digital look or one or more fashion articles associated with the digital look.

19. A system for managing digital looks, comprising:
(a) a computing device configured to provide a consumer with a link to access a digital look, wherein the digital look comprises a virtual arrangement of one or more fashion articles selected by an algorithm or an individual who is not the consumer; and
(b) a digital platform configured to provide a user interface for the consumer to (i) view and modify the one or more fashion articles in the digital look and (ii) select at least one or more fashion articles to purchase, wherein the user interface is configured to provide the consumer with a purchase list corresponding to the one or more fashion articles in the digital look.

20. The system of claim 19, wherein the user interface is configured to update the purchase list or an item pricing in real time based on (i) the consumer's selection of the one or more fashion articles for purchasing or (ii) the consumer's modification or customization of the digital look or one or more fashion articles associated with the digital look.
